(19) United States
(12) Patent Application Publication
(10) Pub. No.: US 2006/0106721 A1
(43) Pub. Date: May 18, 2006

(54) Method for retransmitting or restoring contents key for decrypting encrypted contents data

(76) Inventors: Yoshihiro Hori, Gifu-City (JP); Takatoshi Yoshikawa, Hirakata-City (JP)

Correspondence Address: MCDERMOTT WILL & EMERY LLP, 600 13TH STREET, N.W., WASHINGTON, DC, 20005-3096, US

(21) Appl. No.: 11/260,490

(22) Filed: Oct. 28, 2005

(30) Foreign Application Priority Data
Oct. 28, 2004 (JP) JP 2004-313810
Oct. 29, 2004 (JP) JP 2004-315684
Oct. 21, 2005 (JP) JP 2005-307717

(51) Int. Cl. H04L 9/00

(52) U.S. Cl. 705/51

(57) ABSTRACT

To provide a license data providing device having a function for restoring license data in writing of the license data from the license providing device to a storage device and so forth, even in a case that the license data has been lost during transmission due to an undesired situation such as failure of the power supply or the like, or a case that the receiver has failed in processing for the transmitted license data, thereby protecting the right of the user for reproduction of contents. The license data providing device includes: an encrypted communication path establishing unit for establishing an encrypted communication path used for exchange of data with the storage device; a log storage unit for storing information regarding exchange of data with the storage device through the encrypted communication path, including information for identifying the storage device; and a retransmission/output determination unit for determining whether or not the contents usage right information should be restored, based upon the information regarding exchange of data, stored in the log storage unit.

### BACKGROUND OF THE INVENTION

1. Field of the Invention

The present invention relates to a technique for transmitting content usage right information, and particularly to an apparatus for providing content usage right information including a content key for decrypting encrypted content data and a method thereof.

2. Description of the Related Art

As a copyright protection method for protecting contents data, a contents management method is well known in which contents data is encrypted, and contents usage right information (which will be referred to as “license data” hereafter) including a decryption key (which will be referred to as “contents key” hereafter) for decrypting the encrypted contents data is managed with high security (see Patent document 1, for example). With a contents data distribution system disclosed in Patent document 1, examples of the devices handling the license data in a non-encrypted form includes three devices of a server device, a memory card serving as a storage device, and a decoder serving as a user device. With such a contents data distribution system, an encrypted commination path is established between the server device and the storage device, and between the storage device and the user device. With such a configuration, the license data is exchanged through the encrypted communication path. Each of the server device, the storage device, and the user device, includes a TRM (Tamper Resistant Module) for handling encrypted license data.

With establishment of the encrypted communication path, first, a device providing license data (which will be referred to as “license provider”) transmits a certificate including a public key to a device receiving the license data (which will be referred to as “license receiver”). Then, the license provider verifies the certificate. As a result of the verification, only in a case that determination has been made that the certificate received from the license provider is valid, and is not listed in the certificate revocation list, key sharing is performed between the two devices using the public key included in the certificate. Then, the license provider transmits the license data, which has been encrypted using a key transmitted from the license provider to the license receiver, to the license receiver. The TRM is a circuit module which physically protects the security thereof. The TRM has a configuration which does not allows access from external circuits, except through the encrypted communication path.

Note that in a case of acquisition of the license data, the memory card, which is mounted to a terminal device having a function of communication with the server, receives the license data from the server through the terminal device. In this case, the server serves as a license transmitter, and the memory card serves as a license receiver. On the other hand, in a case of using contents, the memory card, which is mounted to the terminal device including a built-in decoder, transmits the license data to the decoder through the terminal device. In this case, the memory card serves as a license transmitter, and the decoder serves as a license receiver.

Furthermore, with such a system, the memory card has a function for restricting the output of the license data according to restriction information contained in the license data. For example, the license data contains control information which indicates the number of times that reproduction of the contents data is permitted using the license data. At the time of reproduction, the memory card checks the restriction information, i.e., the number of times reproduction is permitted, contained in the license data, thereby determining whether or not the license data permits output thereof. The control information is updated for each output of the license data. In a case that the number of times of reproduction has reached the limit due to repeated reproduction, the output of the license data is forbidden.

Furthermore, with such a copyright protection method, the memory card has a function for controlling the move of the license data. That is to say, in the event that the memory card has output the license data for purpose of the move of the license data, the output of the license data from the memory card is forbidden after the output of the license data.

As described above, such a copyright protection method provides encryption of the contents data and security of the license data, thereby ensuring copyright protection with regard to the contents. Furthermore, the copyright protection method employs usage restriction such as reproduction-times control, copying-times control, and so forth, and the move control. This allows this copyright protection method to be applied to various distribution services and recording of a digital broadcasting program.

The aforementioned conventional contents protection system has a problem as follows. Let us say that the license data is written to the storage device from the license provider. Alternatively, let us say that the storage device provides the license data to the license using device with output-times restriction or for purpose of the move thereof. In such cases, in the event that the license data has been lost in transmission thereof, or the receiver has failed in processing the received license data due to an undesired situation such as power failure or the like.

Patent Document 1:
International Publication WO01/43342

### SUMMARY OF THE INVENTION

The present invention has been made in view of the aforementioned problems. Accordingly, it is an object thereof to provide a technique for protecting the right of the user as well as the copyright of contents.

The present invention has the features as follows in view of the aforementioned problems.

In order to solve the aforementioned problems, with a contents usage right information transmission method according to an aspect of the present invention, the contents usage right information transmission method for transmitting contents usage right information including a contents key for decrypting encrypted contents data comprises: sharing at least one encryption/decryption key between a transmitter and a receiver for transmission/reception of the contents usage right information; processing in which the transmitter transmits the encrypted contents usage right information to the receiver in an encrypted form using the at least one encryption/decryption key; processing in which the transmitter stores identification information regarding the contents usage right information, which is transmitted to the receiver, in a log storage unit in a form correlated with identification information regarding the receiver; notifying a retransmission receiver of identification information regarding the contents usage right information, which is to be retransmitted, in a case that the contents usage right information needs to be retransmitted; processing in which the retransmission receiver confirms the status of the contents usage right information, which is to be retransmitted, based upon the identification information regarding the contents usage right information thus received, creates transaction status information including the identification information, which is to be retransmitted, and the status information regarding the contents usage right information, and transmits the transaction status information to the transmitter; processing in which the transmitter acquires the transaction status information, and determines whether or not transmission of the contents usage right information, which is to be retransmitted to the retransmission receiver, is permitted, and processing in which in the event that transmission has been permitted, the transmitter retransmits the contents usage right information, which is to be retransmitted, to the retransmission receiver. With the aforementioned contents usage right information transmission method, in the determination step, in the event that the identification information regarding the contents usage right information included in the transaction status information is held in the log storage unit in a form correlated with the identification information regarding the retransmission receiver, and the status information regarding the contents usage right information indicates that the contents usage right information, which is to be retransmitted, is not stored in the retransmission receiver, transmission of the contents usage right information, which is to be retransmitted to the retransmission receiver, is permitted.

An arrangement may be made as follows. That is to say, in the determination step, in the event that the status information regarding the contents usage right information indicates that the contents usage right information, which is to be retransmitted, is stored in the retransmission receiver, or indicates that the contents usage right information has been moved after reception, transmission of the contents usage right information, which is to be retransmitted to the retransmission receiver, is forbidden.

An arrangement may be made as follows. That is to say, the retransmission receiver calculates a hash value of linked data in which the encryption/decryption key shared with the transmitter and the transaction status information have been linked, and transmits the hash value and the transaction status information to the transmitter. Furthermore, in the determination step, a hash value is calculated from linked data in which the transaction status information received from the retransmission receiver and the encryption/decryption key shared with the receiver have been linked, and validity of the transaction status information is verified by making a comparison between the hash value thus calculated and the hash value received from the retransmission receiver. Furthermore, in the event that these hash values do not match one another, transmission of the contents usage right information, which is to be retransmitted to the retransmission receiver, is forbidden.

The contents usage right information transmission method may further include a processing in which upon receiving a notification that the receiver has received the contents usage right information successfully after transmission of the contents usage right information to the receiver, the identification information regarding the contents usage right information is deleted from the log storage unit. Also, an arrangement may be made as follows. That is to say, upon connection of the transmitter to the retransmission receiver, identification information regarding the retransmission receiver is acquired. Furthermore, in the event that the log storage unit stores the identification information regarding the contents usage right information in a form correlated with the identification information regarding the retransmission receiver, determination is made that the contents usage right information needs to be retransmitted.

The contents usage right information transmission method may further include a processing in which upon connection of the transmitter to the retransmission receiver, the transmitter acquires the identification information regarding the retransmission receiver, and the identification information regarding the contents usage right information, which is stored in the log storage unit in a form correlated with the identification information different from the identification information regarding the retransmission receiver, is deleted from the log storage unit.

The log storage unit may further hold an address at which the contents usage right information is stored in the receiver. Furthermore, the transaction status information may further include an address at which the contents usage right information has been stored or is to be stored in the retransmission receiver. Also, an arrangement may be made as follows. That is to say, in the determination step, comparison is made between the address held in the log storage unit and the address included in the transaction status information. Furthermore, in the event that these addresses do not match one another, transmission of the contents usage right information, which is to be retransmitted to the retransmission receiver, is forbidden.

An arrangement may be made as follows. That is to say, the log storage unit further holds the contents usage right information transmitted to the receiver. Furthermore, in the retransmission step, the contents usage right information read out from the log storage unit is transmitted.

An arrangement may be made as follows. That is to say, the log storage unit further holds transmitter session information which indicates the status of transmission of the contents usage right information to the receiver. Furthermore, in the determination step, in the event that the transmitter session information held in the log storage unit for the contents usage right information, which is to be retransmitted, indicates that the transmission of the contents usage right information has been completed, transmission of the contents usage right information, which is to be retransmitted to the retransmission receiver, is permitted.

The transaction status information may further include receiver session information which indicates the status of reception of the contents usage right information. Furthermore, an arrangement may be made as follows. That is to say, in the determination step, in the event that the receiver session information included in the transaction status information indicates that reception of the contents usage right information, which is to be retransmitted, has not been completed, or in the event that the receiver session information included in the transaction status information indicates that reception of the contents usage right information, which is to be retransmitted, has been completed, and the status information regarding the contents usage right information included in the transaction status information indicates that the contents usage right information, which is to be retransmitted, is not stored in the retransmission receiver, transmission of the contents usage right information, which is to be retransmitted to the retransmission receiver, is permitted.

Another aspect of the present invention relates to a contents usage right information providing device. The contents usage right information providing device which provides contents usage right information containing a contents key for decrypting encrypted contents data to a contents usage right information receiving device which uses the contents usage right information, comprises: encryption key sharing means for sharing at least one encryption key with the contents usage right information receiving device, which is used for transmission of the contents usage right information to the contents usage right information receiving device; contents usage right information transmission means for transmitting the contents usage right information to the contents usage right information receiving device in a form encrypted with the at least one encryption key; log storage means for storing identification information regarding the contents usage right information, which is to be transmitted to the contents usage right information receiving device, in a log storage unit in a form correlated with the identification information regarding the contents usage right information receiving device; status information acquisition means for acquiring identification information regarding the content usage right information, which is to be retransmitted, and transaction status information including status information regarding the contents usage right information corresponding to the contents usage right information receiving device, in the event that there is the need to retransmit the contents usage right information; and retransmission determination means in which in the event that the identification information regarding the contents usage right information included in the transaction status information acquired by the status information acquisition means is held in the log storage unit in a form correlated with the identification information regarding the contents usage right information receiving device serving as a retransmission receiver, and the status information regarding the contents usage right information indicates that the contents usage right information, which is to be retransmitted, is not stored in the contents usage right information receiving device serving as a retransmission receiver, retransmission of the contents usage right information, which is to be retransmitted to the contents usage right information receiving device serving as a retransmission receiver, is permitted.

An arrangement may be made as follows. That is to say, with the retransmission determination means, in the event that the status information regarding the contents usage right information indicates that the contents usage right information, which is to be retransmitted, is stored in the contents usage right information receiving device serving as a retransmission receiver, or indicates that the contents usage right information has been moved after reception, transmission of the contents usage right information, which is to be retransmitted to the retransmission receiver, is forbidden.

An arrangement may be made as follows. That is to say, the status information acquisition means acquire the transaction status information and a hash value of linked data, in which the encryption key and the transaction status information have been linked, from the contents usage right information receiving device serving as a retransmission receiver. Furthermore, with the retransmission determination means, a hash value is calculated from linked data in which the transaction status information acquired by the status information acquisition means and the encryption key shared with the contents usage right information receiving device have been linked, and validity of the transaction status information is verified by making a comparison between the hash value thus calculated and the hash value acquired by the status information acquisition means. Furthermore, in the event that these hash values do not match one another, transmission of the contents usage right information, which is to be retransmitted to the retransmission receiver, is forbidden.

An arrangement may be made as follows. That is to say, with the log storage means, upon receiving a notification from the contents usage right information receiving device that the contents usage right information receiving device has received the contents usage right information successfully after transmission of the contents usage right information to the contents usage right information receiving device, the identification information regarding the contents usage right information is deleted from the log storage unit. Furthermore, with the status information acquisition means, upon connecting to the contents usage right information receiving device serving as a retransmission receiver, identification information regarding the retransmission receiver is acquired. Furthermore, in the event that the log storage unit stores the identification information regarding the contents usage right information in a form correlated with the identification information regarding the contents usage right information receiving device serving as a retransmission receiver, determination is made that the contents usage right information needs to be retransmitted, and the status information acquisition means acquire the transaction status information.

An arrangement may be made as follows. That is to say, upon connection to the contents usage right information receiving device serving as a retransmission receiver, the log storage means acquire the identification information regarding the retransmission receiver, and delete the identification information regarding the contents usage right information, which is stored in a form correlated with the identification information different from the identification information regarding the contents usage right information receiving device serving as a retransmission receiver.

The log storage means may further hold an address at which the contents usage right information is stored in the contents usage right information receiving device. Furthermore, the transaction status information may further include an address at which the contents usage right information has been stored or is to be stored in the contents usage right information receiving device serving as a retransmission receiver. Furthermore, an arrangement may be made as follows. That is to say, the retransmission determination means make a comparison between the address held in the log storage unit and the address included in the transaction status information. Furthermore, in the event that these addresses do not match one another, transmission of the contents usage right information, which is to be retransmitted to the contents usage right information receiving device serving as a retransmission receiver, is forbidden.

An arrangement may be made as follows. That is to say, with the log storage means, the log storage unit further stores the contents usage right information transmitted to the contents usage right information receiving device. Furthermore, in a case of retransmission of the contents usage right information, which is to be retransmitted, to the contents usage right information receiving device serving as a retransmission receiver, the contents usage right information transmission means transmit the contents usage right information read out from the log storage unit.

An arrangement may be made as follows. That is to say, the log storage means further store transmitter session information which indicates the status of transmission of the contents usage right information to the contents usage right information receiving device. Furthermore, with the retransmission determination means, in the event that the transmitter session information held in the log storage unit for the contents usage right information, which is to be retransmitted, indicates that the transmission of the contents usage right information has been completed, transmission of the contents usage right information, which is to be retransmitted to the contents usage right information receiving device serving as a retransmission receiver, is permitted.

An arrangement may be made as follows. That is to say, the transaction status information further includes receiver session information which indicates the status of reception of the contents usage right information. Furthermore, with the retransmission determination means, in the event that the receiver session information included in the transaction status information indicates that reception of the contents usage right information, which is to be retransmitted, has not been completed, or in the event that the receiver session information included in the transaction status information indicates that reception of the contents usage right information, which is to be retransmitted, has been completed, and the status information regarding the contents usage right information included in the transaction status information indicates that the contents usage right information, which is to be retransmitted, is not stored in the contents usage right information receiving device serving as retransmission receiver, transmission of the contents usage right information, which is to be retransmitted to the contents usage right information receiving device serving as a retransmission receiver, is permitted.

The features and technological significance of the present invention will become apparent from the following description of the embodiments. It should be clearly understood that the embodiments will be described for exemplary purposes only, and that the meanings of the technical terms given in this description of the present invention or the components thereof by way of embodiments are by no means intended to be interpreted restrictively.

### BRIEF DESCRIPTION OF THE DRAWINGS

FIG. 1 is a diagram which shows a configuration of a data management system;

FIG. 2 is a diagram which shows a configuration of a license providing device;

FIG. 3 is a diagram which shows a configuration of a license using device;

FIG. 4 is a diagram which shows a configuration of a storage device;

FIG. 5 is a diagram which shows a configuration of a cipher engine shown in FIG. 2;

FIG. 6 is a diagram which shows a configuration of a cipher engine shown in FIG. 3;

FIG. 7 is a diagram which shows a configuration of a cipher engine shown in FIG. 4;

FIG. 8 is a diagram for describing a recording procedure for license data;

FIG. 9 is a diagram for describing the recording procedure for the license data;

FIG. 10 is a diagram for describing a wiring/transmission processing for the license data;

FIG. 11 is a diagram for describing rewriting/transmission processing for the license data:

FIG. 12 is a diagram for describing processing using the license data;

FIG. 13 is a diagram for describing processing using the license data;

FIG. 14 is a diagram for describing rereading/transmission processing for the license data; and

FIG. 15 is a diagram for describing readout/transmission processing for the license data.

### DETAILED DESCRIPTION OF THE INVENTION

Description will be made below regarding embodiments with reference to the drawings.

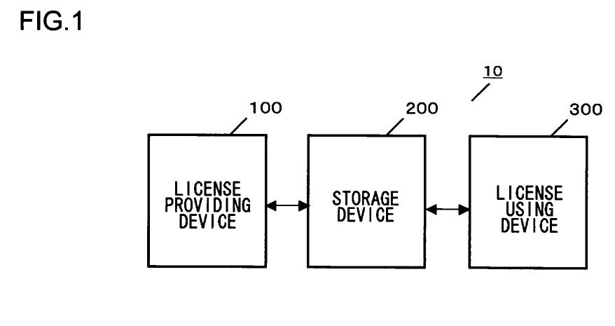

FIG. 1 shows an overall configuration of a data management system 10 according to an embodiment. The data management system 10 includes: a license data providing device 100 which provides license data to a storage device 200; a license using device 300 which reads out and uses the license data stored in the storage device 200; and the storage device 200 for storing and holding data. Examples of the use of the license data include: decryption of the encrypted contents data using the license data in order to reproduce contents; recording of contents on another recording medium; and so forth.

The term storage device 200 as used in the present embodiment does not represent a recording medium alone for storing data. Rather, the storage device 200 is a storage device with a built-in drive. The storage device 200 includes a controller and so forth for controlling input/output of data between: a host device such as the license providing device 100, the license using device 300, and so forth; and the recording medium. Description will be made in the present embodiment regarding an arrangement employing a hard disk drive as the storage device 200.

In general, conventional hard disk drives are used in the state in which each hard disk drive is fixedly connected to a certain host device. On the other hand, the storage device 200 according to the present embodiment has a configuration which allows detachable mounting thereof to a host device such as the license providing device 100, the license using device 300, and so forth. That is to say, with the present embodiment, the user can detach the storage device 200 from the host device in the same way as with CD, DVD, and so forth. This allows the storage device 200 to be shared between multiple host devices such as a license providing/using device having both functions of recording and using, a terminal device connected to the license providing device 100 or the license using device 300 through a communication cable or a communication network, as well as the license providing device 100 and the license using device 300.

As described above, the storage device 200 according to the present embodiment is designed to have a function of being shared between multiple host devices. This may lead a problem that the data stored in the storage device 200 is read out by a third party through an unauthorized host device. Let us say that the storage device 200 stores contents such as audio contents, video contents, and so forth, protected by the copyright, or confidential information such as confidential corporation information, confidential personal information, and so forth. In order to prevent leakage of such kinds of confidential data, the storage device 200 preferably has a proper configuration for protecting the data, i.e., preferably has a sufficient tamper-resistant function.

From such a perspective, the storage device 200 according to the present embodiment has a configuration which allows exchange of confidential data in an encrypted form between the storage device 200 and the host device at the time of input/output of the confidential data therebetween. Furthermore, the storage device 200 has a confidential data storage area separate from an ordinary storage area, for storing confidential data. With such a configuration, no external circuit can access the confidential data storage area except through a cipher engine included in the storage device 200. The cipher engine allows input/output of confidential data to/from a host device, only in a case that the host device has been verified as an authorized host device. Such a data protection function will also be referred to as “secure function” hereafter. The aforementioned configuration and function provide proper protection of the confidential data stored in the storage device 200.

The secure function of the storage device 200 is preferably designed so as to maintain the advantages of serving as a removable medium as much as possible. That is to say, the storage device 200 is preferably designed so as to allow input/output of ordinary data to/from a host device, even if the host device has no secure function. Accordingly, the storage device 200 according to the present embodiment is designed stipulated by ATA (AT attachment) which is a standard of ANSI (American National Standards Institute), thereby maintaining compatibility with conventional hard disks. The aforementioned secure function is realized in the form of expanded commands of ATA.

Description will be made below regarding an example of input/output of confidential data in which the contents data such as video contents are recorded/reproduced. While the contents data may be handled as confidential data, description will be made below regarding an arrangement according to the present embodiment in which the contents data is encrypted, while the contents data thus encrypted is stored in the storage device 200 as ordinary data. Furthermore, the system handles a contents key and license data as the confidential data using the aforementioned secure function. Note that the contents key as used here represents a key for decrypting the contents data thus encrypted. On the other hand, the license data as used here represents the data including information (which will be referred to as “user agreement” hereafter) regarding control for reproduction of the contents, and control for the usage, transmission, and duplication of the license. This enables input/output of data in a simple manner while maintaining the sufficient tamper-resistant function, thereby enabling high-speed processing with reduced power consumption.

With the present embodiment, the license data includes identifying information LID for identifying the license data as well as the contents key and the user agreement. Furthermore, the user agreement includes control information PC for determining the maximum number of times for which output of the license data for the purpose of reproduction thereof is permitted. Let us say that the control information PC is defined as follows. That is to say, the control information PC is represented by an unsigned integer of one byte, which indicates the maximum number of times the license data can be output. With such a configuration, the control information PC is decremented by 1 for each output of the license data. Note that the control information PC of 255 is a special value which indicates that the license data can be reproduced without an upper limit number of times. That is to say, in a case that the control information PC is set to 255, the value of the control information PC is maintained regardless of output of the license data for the purpose of reproduction thereof. Note that the methods for setting and operation of the control information PC according to the present embodiment have been described for exemplary purposes only, and are not restricted in particular.

Of commands issued by the host device such as the license providing device 100, the license using device 300, and so forth, to the storage device 200, the expanded commands for the secure function will be referred to as “secure commands” hereafter. On the other hand, the other commands will also be referred to as “ordinary commands” hereafter.

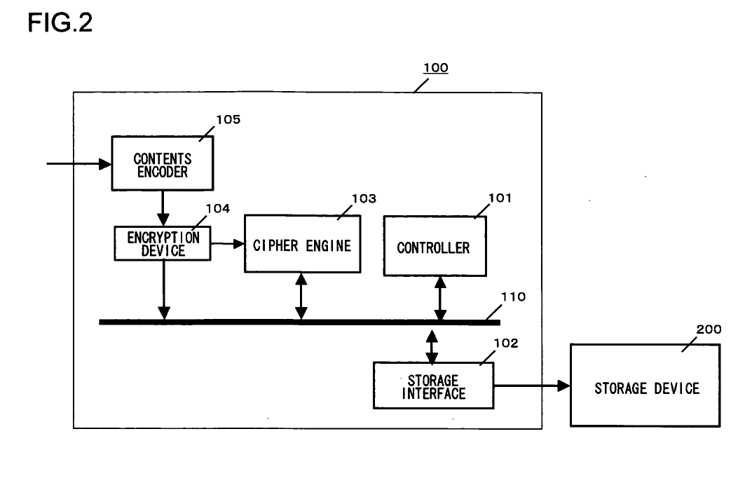

FIG. 2 shows an internal configurations of the license providing device 100 according to the present embodiment. The license providing device 100 is a recording device for recording video data on the storage device 200. Such a configuration may be realized by hardware means, e.g., by actions of a CPU, memory, and other LSIs, of a computer, and by software means, e.g., by actions of a program or the like, loaded to the memory. Here, the drawing shows a functional block configuration realized by cooperation of the hardware components and software components. It is needless to say that such a functional block configuration can be realized by hardware components alone, software components alone, or various combinations thereof, which can be readily conceived by those skilled in this art.

The license providing device 100 principally includes a controller 101, a storage interface 102, a cipher engine 103, an encryption device 104, a contents encoder 105, and a data bus electrically connected therebetween.

The contents encoder 105 encodes the contents, acquired on-line or off-line, in a predetermined format. Description will be made below regarding an example in which video data acquired from a broadcast wave or the like is encoded in the MPEG format.

The encryption device 104 issues license data LIC containing a contents key for decrypting encrypted contents. The contents data, which has been encoded by the contents encoder 105, is encrypted using the contents key. The encrypted contents data is stored in the storage device 200 through a data bus 110 and the storage interface 102. The license data LIC thus issued is transmitted to the cipher engine 103. The storage device 200 stores the license data LIC through the cipher engine 103.

The cipher engine 103 controls encrypted communication with the storage device 200 for input of the license data LIC in the storage device 200. The storage interface 102 controls input/output of data with the storage device 200. The controller 101 centrally controls the components of the license providing device 100.

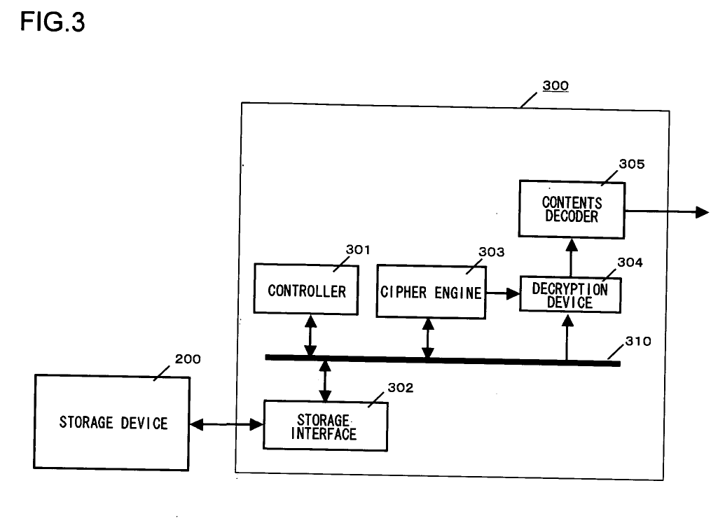

FIG. 3 shows an internal configuration of the license using device 300 according to the present embodiment. The license using device shown in FIG. 3 is a reproducing device for reproducing video contents using the video data, which has been encrypted with license data, and the corresponding license data read out. The aforementioned functional block configuration can be realized by hardware components alone, software components alone, or various combinations thereof.

The license using device 300 principally includes a controller 301, a storage interface 302, a cipher engine 303, a decryption device 304, a contents decoder 305, and a data bus 310 for electrically connecting these components to each other.

The storage interface 302 controls input/output of data to/from the storage device 200. The cipher engine 303 controls encrypted communication between the storage device 200 and the license using device 300, thereby enabling reception of the license data LIC containing the contents key from the storage device 200. The decryption device 304 decrypts the encrypted contents data read out from the storage device 200 using the contents key contained in the license data LIC received from the storage device 200. The contents decoder 305 decodes the contents data decrypted by the decryption device 304, and outputs the decoded contents data. Let us say that the contents data is encoded in the MPEG format. In this case, the contents decoder 305 reproduces the video signal and the audio signal from the contents data. The video signal thus reproduced is displayed on an unshown display device. On the other hand, the audio signal thus reproduced is output to an unshown speaker. The controller 301 centrally controls the components of the license using device 300.

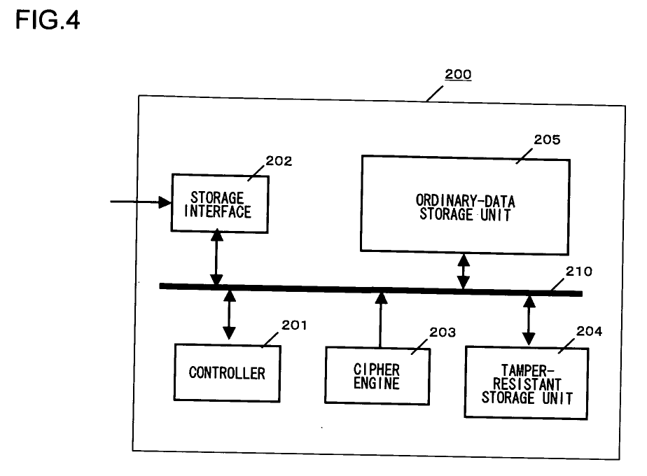

FIG. 4 shows an internal configuration of the storage device 200 according to the present embodiment. The storage device 200 principally includes a controller 200, a storage interface 202, a cipher engine 203, a tamper-resistant storage unit 204, an ordinary-data storage unit 205, and a data bus 210 for electrically connecting these components to each other.

The storage interface 202 controls input/output of data to/from the license providing device 100 and the license using device 300. The cipher engine 203 controls encrypted communication for input/output of confidential data such as the license data LIC containing the contents key to/from the license providing device 100 and the license using device 300. The ordinary-data storage unit 205 serves as an ordinary-data storage area for storing the encrypted contents data, ordinary data, and so forth. On the other hand, the tamper-resistant storage unit 204 serves as a confidential-data storage area for storing confidential data such as the license data LIC containing the contents key. The ordinary-data storage unit 205 has a configuration which allows direct access from external circuits for input/ougput of data. On the other hand, the tamper-resistant storage unit 204 has a configuration which does not allow access from external circuits for input/output of data, except through the cipher engine 203. The controller 201 centrally controls these components of the storage device 200.

Now, description will be made regarding the keys employed in the present embodiment. In the present embodiment, all the keys are represented by text strings beginning with a capital K. Furthermore, a symmetric key (shared key) is represented by a text string in which the second letter is a lowercase “c”, “s”, or “b”. More specifically, a challenge key is represented by a text string in which the second letter is a lowercase “c”. Note that the challenge key is a temporary symmetric key created by a transmitter of the license data. Also, a session key is represented by a text string in which the second letter is a lowercase “s”. Note that the session key is a temporary symmetric key created by a receiver of the license data. Also, a bus key is represented by a text string in which the second letter is a lowercase “b”. Note that the bus key is a temporary symmetric key created by a receiver of the license data. On the other hand, a public key is represented by a text string in which the second letter is a capital “P”. Also, a private key forming a pair along with the public key is always prepared, which is represented by a text string in which the second letter, i.e., the capital “P” is stripped from the text string representing the public key.

Furthermore, the key prepared for each device group is represented by a text string containing a lowercase “d”. On the other hand, the key prepared for each device is represented by a text string containing a lowercase “p”. These keys are prepared in the form of a pair of a public key and a private key. Note that the public key KPdx for each group is provided in the form of a public key certificate C[KPdx] including a digital signature.

On the other hand, the last letter of each text string which represents a key, e.g., the numeral “2”in the text string KPd2 representing a public key, serves as an index for identifying the cipher engine from which the key has been provided. In the present embodiment, the key provided by a specified cipher engine is represented by a text string in which the last letter is a numeral “1”, “2”, or “3”. On the other hand, the keys provided by unspecified components other than the aforementioned cipher engines are represented by text strings in which the last letter is a letter of the English alphabet such as “x”, “y”, and so forth. In the present embodiment, the key provided by the cipher engine 103 of the license providing device 100 is represented by the index numeral “1”. The key provided by the cipher engine 203 of the storage device 200 is represented by the index numeral “2”. The key provided by the cipher engine 303 of the license using device 300 is represented by the index numeral “3”.

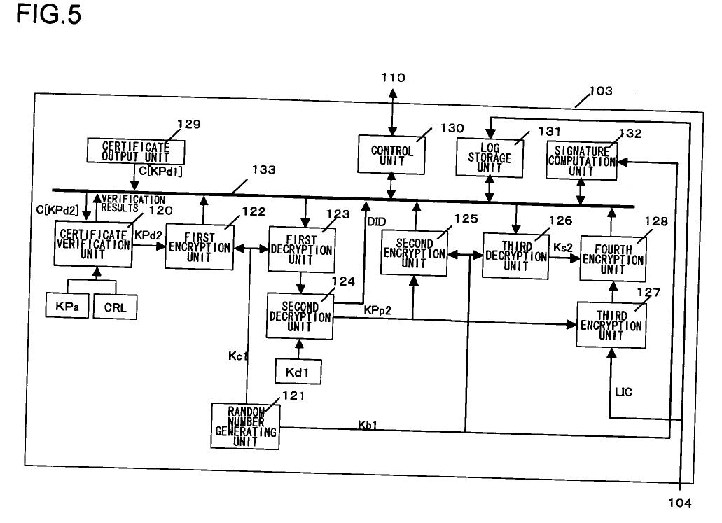

FIG. 5 shows an internal configuration of the cipher engine 103 of the license providing device 100 shown in FIG. 2. The cipher engine 103 includes a certificate verification unit 120, a random number generating unit 121, a first encryption unit 122, a first decryption unit 123, a second decryption unit 124, a second encryption unit 125, a third decryption unit 126, a third encryption unit 127, a fourth encryption unit 128, a certificate output unit 129, a control unit 130, a log storage unit 131, a signature computation unit 132, and a local bus 133 for electrically connecting at least a part of these components to each other.

The certificate verification unit 120 verifies the certificate C[KPd2] acquired from the storage device 200. The certificate C[KPd2] is formed of unencrypted information (which will be referred to as “certificate body” hereafter) containing the public key KPd2, and a digital signature appended to the certificate body. The digital signature is created as follows. That is to say, first, the certificate body is subjected to computation using the hash function (which will be referred to as “hash computation” hereafter). Next, the computation result is encrypted using a root key Ka held by an Certificate Authority (not shown) which is a third party organization, thereby creating the digital signature. Note that the root key Ka is a non-public key which is strictly managed by the Certificate Authority. That is to say, the root key Ka is a private key of the Certificate Authority. The certificate verification unit 120 holds a verification key KPa which forms a pair with the root key Ka. The verification key KPa is a public key for verifying the validity of the certificate. The verification of the certificate is made based upon the validity of the certificate, which is to say that the certificate has not been forged, and that the certificate has not been revoked.

That the certificate has not been forged is confirmed based upon comparison results between: the computation result obtained by performing hash function computation for the certificate body of the certificate which is to be verified; and the computation result obtained by decrypting the digital signature using the verification key KPa. In a case that these results match one another, the certificate verification unit 120 determines that the certificate has not been forged. Furthermore, the certificate verification unit 120 holds a certificate revocation list (which will be abbreviate to “CRL”) which is a list of revoked certificates which accordingly have been invalidated. In a case that determination has been made that the certificate which is to be verified is not listed in the CRL, the certificate verification unit 120 determines that the certificate has not been revoked. In the present embodiment, such processing for determining whether or not the certificate is valid, i.e., the certificate has not been forged and revoked, and authenticating the valid certificate, will be referred to as “verification”.

Upon success of verification, the certificate verification unit 120 acquires the public key KPd2 of the storage device 200. Then, the certificate verification unit 120 transmits the public key KPd2 to the first encryption unit 122, as well as making a notification of the verification results. In a case of failure in verification, the certificate verification unit 120 outputs a verification error notification.

The certificate output unit 129 outputs a certificate C[KPd1] of the license providing device 100. The certificate is formed of a certificate body containing the public key KPd1 of the license providing device 100 and a digital signature appended to the certificate body. The digital signature is encrypted using the root key Ka of Certificate Authority in the same way as with the certificate of the storage device 200.

The random number generating unit 121 generates a challenge key Kc1 and a bus key kb1 temporarily used for encrypted communication between the license providing device 100 and the storage device 200. The random number generating unit 121 generates the challenge key Kc1 each time that encrypted communication is performed, thereby minimizing the risk of the challenge key being cracked. The generated challenge key Kc1 is transmitted to the first encryption unit 122, and the first decryption unit 123. On the other hand, the bus key kb1 is transmitted to the second encryption unit 125, the third decryption unit 126, and the signature computation unit 132.

In order to notify the storage device 200 of the challenge key Kc1, the first encryption unit 122 encrypts the challenge key Kc1 using the public key KPd2 of the storage device 200 acquired by the certificate verification unit 120, thereby creating an encrypted challenge key E(KPd2, Kc1). Then, the encrypted challenge key E(KPd2, Kc1) is linked to the certificate C[KPd1] output from the certificate output unit 129, thereby creating first challenge information E(KPd2, Kc1)//C[KPd1].

Here, the symbol “//” represents data linking. For example, Expression E(KPd2, Kc1)//C[KPd1] represents a data sequence in which the encrypted challenge key E(KPd2, Kc1) and the certificate C[KPd1] are serially linked with each other. On the other hand, the symbol “E” represents an encryption function. For example, Expression E(KPd2, Kc1) represents a function for encrypting the challenge key Kc1 using the public key KPd2.

The first decryption unit 123 decrypts the encrypted data using the challenge key Kc1. The storage device 200 provides: a public key KPp2 forming a pair with a private key Kp2 which is an unique private key held by the storage device 200 with high security; and an unique identification information DID for identifying the unique storage device 200, in the form of encrypted information, i.e., second challenge information E(Kc1, E(KPd1, KPp2//DID)). The first decryption unit 123 decrypts the second challenge information using the challenge key Kc1 generated by the random number generating unit 121, thereby acquiring the encrypted data E(KPd1, KPp2//DID).

The second decryption unit 124 decrypts the data encrypted with the public key KPd1 thereof, using a private key Kd1 held by the license providing device 100 with high security. Specifically, the second decryption unit 124 decrypts the encrypted data E(KPd1, KPp2//DID) transmitted from the first decryption unit 123, thereby acquiring the public key KPp2 and the identification information DID.

In order to notify the storage device 200 of the bus key kb1, the second encryption unit 125 encrypts the bus key kb1 with the public key KPp2 of the storage device 200, thereby creating an encrypted bus key E(KPp2, Kb1). The encrypted bus key is provided to the storage device 200 without additional processing, i.e., in the form of connection information E(KPp2, Kb1). Alternatively, the encrypted bus key is provided to the storage device 200 in the form of status request information E(Kpp2, Kb1)//LID//ADR//H(Kb1//LID//ADR). The status request information has a data structure in which the encrypted bus key E(KPp2, Kb1), the LID stored in the log storage unit 131, the address data ADR of the storage device 200 in which the license data corresponding to the LID is to be stored, and the hash computation result H with respect to the data sequence Kb1//LID//ADR, are linked. Note that H(Kb1//LID//ADR) serves as a digital signature for the data sequence LID//ADR.

The third decryption unit 126 decrypts the data which has been encrypted with the bus key Kb1. Specifically, the storage device 200 issues the session key Ks2, and provides the session key Ks2 in the form of session information E(Kb1, Ks2). The third decryption unit 126 decrypts the session information using the bus key Kb1 generated by the random number generating unit 121, thereby acquiring the session key Ks2. The session key Ks2 thus acquired is transmitted to the fourth encryption unit 128.

The third encryption unit 127 acquires the license data LIC containing the contents key issued in the processing in which the encryption device 104 encrypts the contents. Then, the third encryption unit 127 encrypts the license data LIC using the public key KPp2 of the storage device 200, thereby creating E(KPp2, LIC). Subsequently, E(KPp2, LIC) thus created is transmitted to the fourth encryption unit 128.

The fourth encryption unit 128 further encrypts E(KPp2, LIC) transmitted from third encryption unit 127 using the session key Ks2 issued by the storage device 200, thereby creating encrypted license data E(Ks2, E(KPp2, LIC)).

The log storage unit 131 statically stores the identification information DID regarding the storage device 200 transmitted from the second decryption unit 124, the license data LIC to be output to the storage device 200, and the address data ADR of the storage device 200 in which the license data LIC is to be stored, in a correlated form. Note that the license data LIC stored in the log storage unit 131 is output in an encrypted form alone, in response to the access which has been made according to a predetermined procedure.

The signature computation unit 132 links the bus key Kb1 and the data, and performs hash function computation for the linked data. Thus, the signature computation unit 132 creates digital signature data in a keyed-hash format using the bus key Kb1.

The control unit 130 controls the components of the internal configuration of the cipher engine 103, as well as controlling input/output of data to/from external circuits, according to instructions from the controller 101 of the license providing device 100. Note that in FIG. 5, the control connection between the control unit 130 and each component within the encryption unit 103 is omitted.

As shown in FIG. 5, the present embodiment has a configuration which does not allow the cipher engine 103 to exchange data with external circuits, except through the control unit 130. While various arrangements can be conceived for connecting these components, the present embodiment has a configuration in which the keys used in the cipher engine 103 such as the challenge key Kc1 generated by the random number generating unit 121, the session key Ks2 received from the storage device 200, and the private key Kd1 of the license providing device 100, are not directly available to external circuits. This prevents leakage of each key, which is to be used within the cipher engine 103, to external circuits through the other components of the license providing device 100, thereby improving security thereof.

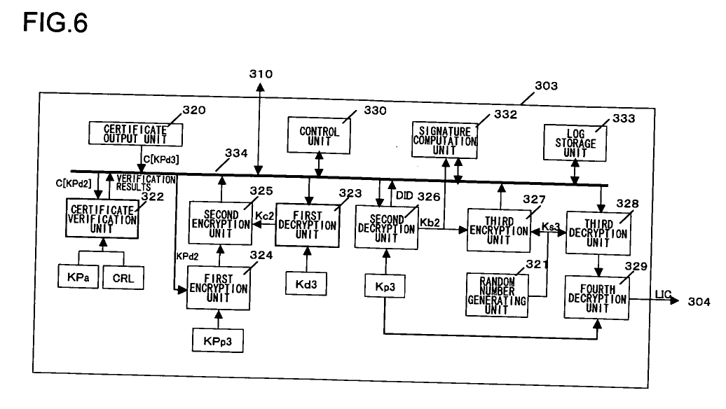

FIG. 6 shows an internal configuration of the cipher engine 303 of the license using device 300 shown in FIG. 3. The cipher engine 303 includes: a certificate output unit 320, a random number generating unit 321, a certificate verification unit 322, a first decryption unit 323, a first encryption unit 324, a second encryption unit 325, a second decryption unit 326, a third encryption unit 327, a third decryption unit 328, a fourth decryption unit 329, a control unit 330, a log storage unit 333, a signature computation unit 332, and a local bus 334 for electrically connecting at least a part of these components.

The certificate output unit 320 outputs a certificate C[KPd3] of the license using device 300. The certificate may be held by the certificate output unit 320. Also, an arrangement may be made in which an unshown certificate holding unit holds the certificate, and the certificate output unit 320 reads out the certificate from the certificate holding unit as necessary. The certificate is formed of the certificate body containing a public key KPd3 of the license using device 300 and a digital signature appended to the certificate body. The digital signature is encrypted using the root key Ka of the Certificate Authority in the same way as with the certificate of the storage device 200.

The random number generating unit 321 generates a session key Ks3 temporarily used for encrypted communication with the storage device 200. The created session key Ks3 is transmitted to the third encryption unit 327, and the third decryption unit 328.

The certificate verification unit 322 verifies the certificate C[KPd2] of the storage device 200. The verification is performed as described above in detail.

The first decryption unit 323 decrypts the data, which has been encrypted using the public key KPd3, using a private key Kd3. In reproduction processing, a challenge key Kc2 issued by the storage device 200 is encrypted using the public key KPd3 of the license using device 300, and the challenge key Kc2 thus encrypted is supplied from the storage device 200. Then, the first decryption unit 323 decrypts the encrypted challenge key Kc2 using the private key Kd3 thereof, thereby acquiring the challenge key Kc2. The challenge key Kc2 thus acquired is transmitted to the second encryption unit 325.

The first encryption unit 324 encrypts data using the public key KPd2 acquired from the certificate C[KPd2] of the storage device 200, thereby creating encrypted data. Specifically, in order to notify the storage device 200 of the public key KPp3 which forms a pair with the private key Kp3 that is a unique key of the license using device 300, the first encryption unit 324 creates an encrypted unique public key E(KPd2, KPp3). The encrypted unique public key E(KPd2, KPp3) thus created is transmitted to the second encryption unit 325.

The second encryption unit 325 encrypts data using the challenge key Kc2 acquired by the first decryption unit 323. Specifically, the second encryption unit 325 encrypts the encrypted unique public key E(KPd2, KPp3) transmitted from the first encryption unit 324, thereby creating second challenge information E(Kc2, E(KPd2, KPp3)).

The second decryption unit 326 decrypts the data which has been encrypted with the public key KPp3. Specifically, the second decryption unit 326 decrypts the connection information E(KPp3, Kb2//DID) provided from the storage device 200, using the private key Kp3 forming a pair with the public key KPp3. Thus, the second decryption unit 326 acquires the bus key Kb2 issued by the storage device 200, and the identification information DID which allows the storage device to be identified.

In order to provide the session key Ks3, generated by the random number generating unit 321, to the storage device 200, the third encryption unit 327 encrypts the session key Ks3 using the bus key Kb2 which has been issued by the storage device 200 and has been acquired by the second decryption unit 326. Thus, the third encryption unit 327 creates session information E(Kb2, Ks3).

The third decryption unit 328 decrypts the encrypted data using the session key Ks3. The license data LIC is supplied from the storage device 200 in the form of the encrypted license data E(Ks3, E(KPp3, LIC)) in which the license data LIC is encrypted twofold using the public key KPp3 and the session key Ks3. Then, the third decryption unit 328 decrypts the encrypted license data E(Ks3, E(KPp3, LIC)) using the session key Ks3 generated by the random number generating unit 321, and transmits the decryption results, i.e., the encrypted license data E(KPp3, LIC) to the fourth decryption unit 329.

The fourth decryption unit 329 decrypts the data which has been encrypted using the public key KPp3. Specifically, the fourth decryption unit 329 decrypts the decryption results received from the third decryption unit 328, i.e., the encrypted license data E(KPp3, LIC) using the private key Kp3 which forms a pair with the public key KPp3. Thus, the license data LIC is acquired.

The log storage unit 333 statically stores the identification information DID regarding the storage device 200 transmitted from the second decryption unit 326, the identification information LID regarding the license data LIC to be received from the storage device 200, and the address data of the storage device 200 storing the license data, in a correlated form. Upon use of the license data LIC, the LID and the ADR with respect to the license data LIC are deleted.

The signature computation unit 332 performs hash-function computation for the data in which the bus key Kb2 and the data have been linked. Thus, the signature computation unit 332 creates digital signature data in a keyed-hash format using the bus key Kb2.

The control unit 330 controls the components within the cipher engine 303, and input/output of data to/from the external components according to instructions from the controller 301 of the license using device 300. Note that in FIG. 6, the control connection between the control unit 330 and each component within the cipher engine 303 is omitted.

With the cipher engine 303 shown in FIG. 6, while various arrangements can be conceived for connecting these components, the present embodiment has a configuration which does not allow the cipher engine 303 to share data with external circuits, except through the control unit 330. This prevents leakage of the keys to be used within the cipher engine 303, such as the session key Ks3 generated by the random number generating unit 321, the private keys Kd3 and Kp3 each of which forms a pair with the corresponding public key, the bus key Kb2 received from the storage device 200, the challenge key Kc2, and so forth, to external circuits.

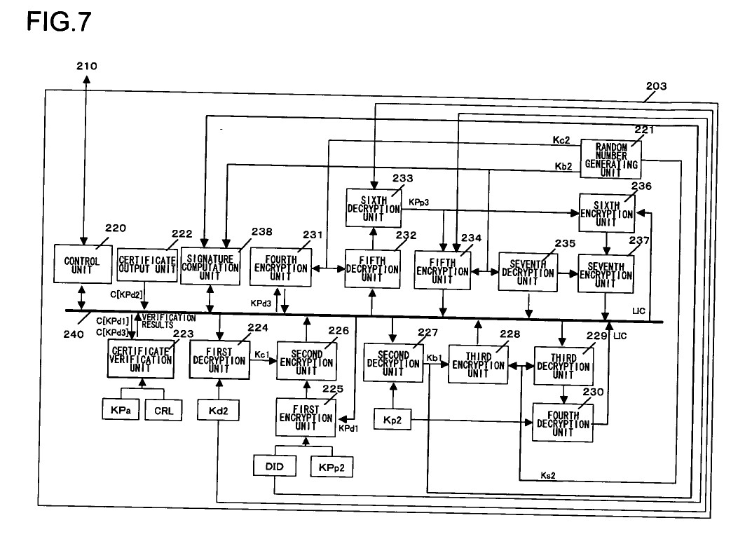

FIG. 7 shows an internal configuration of the cipher engine 203 of the storage device 200 shown in FIG. 4. The cipher engine 203 includes a control unit 220, a random number generating unit 221, a certificate output unit 222, a certificate verification unit 223, a first decryption unit 224, a first encryption unit 225, a second encryption unit 226, a second decryption unit 227, a third decryption unit 228, a third encryption unit 229, a fourth decryption unit 230, a fourth encryption unit 231, a fifth decryption unit 232, a sixth decryption unit 233, a fifth encryption unit 234, a seventh decryption unit 235, a sixth encryption unit 236, a seventh encryption unit 237, a signature computation unit 238, and a local bus 240 for electrically connecting at least a part of these components.

The control unit 220 controls the internal components of the cipher engine 203 and controls input/output of data to/from external components according to instructions from the controller 201 of the storage device 200.

The random number generating unit 221 generates the session key Ks2, the challenge key Kc2, and the bus key Kb2 temporarily used for encrypted communication with either of the license providing device 100 or the license using device 300. Description will be made later regarding the usage of each key.

The certificate output unit 222 outputs the certificate C[KPd2] of the storage device 200. The certificate may be held by the certificate output unit 222. Also, an arrangement may be made in which the certificate is stored in a predetermined storage area in the storage device 200, e.g., the tamper-resistant storage unit 204, and the certificate output unit 222 reads out the certificate therefrom as necessary. The certificate is formed of the certificate body containing the public key KPd2 of the storage device 200 and a digital signature appended to the certificate body. The digital signature is encrypted using the root key Ka of the Certificate Authority.

The certificate verification unit 223 verifies the certificate provided from external components. Specifically, the certificate verification unit 223 verifies the certificate C[KPd1] acquired from the license providing device 100 and the certificate C[KPd3] acquired from the license using device 300 using the verification key KPa. Note that the verification is made as described above in detail.

The first decryption unit 224 decrypts the data which has been encrypted using the public key KPd2 of the storage unit 200. Specifically, in a case of recording the data, the challenge key Kc1 issued by the license providing device 100 is encrypted using the public key KPd2 of the storage device 200, and is provided from the license providing device 100. Then, the first decryption unit 224 decrypts the encrypted challenge key using the private key Kd2 of the storage device 200, thereby acquiring the challenge key Kc1. The challenge key Kc1 thus acquired is transmitted to the second encryption unit 226.

The first encryption unit 225 encrypts data using the public key KPd1 of the license providing device 100. Specifically, the first encryption unit 225 creates the encrypted unique information E(KPd1, KPp2//DID) by encrypting the linked data in which the public key KPp2, which is a unique public key held by the storage device 200, and the identification information DID, which allows identification of the storage device, have been linked. The public key KPd1 of the license providing device 100 used here is acquired from the certificate C[KPd1] of the storage device 200 by the control unit 220, and is transmitted through the local bus 240.

The second encryption unit 226 encrypts data using the challenge key Kc1 issued by the license providing device 100. Specifically, the second encryption unit 226 encrypts the encrypted unique information E(KPd1, KPp2//DID) using the challenge key Kc1, thereby creating second challenge information E(Kc1, E(KPd1, KPp2//DID)).

The second decryption unit 227 decrypts the data which has been encrypted with the public key KPp2 thereof. Specifically, the second decryption unit 227 decrypts the connection information E(KPp2, Kb1) provided from the license providing device 100, using the private key Kp2 which forms a pair with the public key KPp2, and transmits the acquired bus key Kb1 to the third encryption unit 228 and the signature computation unit 238.

The third encryption unit 228 encrypts data using the bus key Kb1. Specifically, the third encryption unit 228 encrypts the session key Ks2 generated by the random number generating unit 221, using the bus key Kb1, thereby creating the session information E(Kb1, Ks2).

The third decryption unit 229 decrypts the encrypted data using the session key Ks2 generated by the random number generating unit 221. Specifically, the third decryption unit 229 receives the encrypted license data LIC from the license providing device 100 in the form of E(Ks2, E(KPp2, LIC)) in which the license data LIC has been encrypted twofold using the public key KPp2 and the session key Ks2. Then, the third decryption unit 229 decrypts the encrypted license data using the session key Ks2, and transmits the decryption results to the fourth decryption unit 230.

The fourth decryption unit 230 decrypts the data which has been encrypted using the public key KPp2 thereof. Specifically, the fourth decryption unit 230 decrypts the encrypted license data E(KPp2, LIC) received from the third decryption unit 229, using the private key Kp2 thereof which forms a pair with the public key KPp2. Thus, the fourth decryption unit 230 acquires the license data LIC.

The license data LIC thus acquired is supplied to the data bus 210 through the local bus 240 and the control unit 220, and is stored in the tamper-resistant storage unit 204 according to instructions from the controller 201.

The fourth encryption unit 231 encrypts the data using the public key KPd3 of the license using device 300. Specifically, in a case of supplying the license data LIC to the license using device 300, the fourth encryption unit 231 encrypts the challenge key Kc2, which has been generated by the random number generating unit 221, using the public key KPd3 acquired from the certificate C[KPd3] received from the license using device 300. Thus, the fourth encryption unit 231 creates an encrypted challenge key E(KPd3, Kc2). The encrypted challenge key E(KPd3, Kc2) thus created is transmitted to the control unit 220 through the local bus 240. The control unit 220 links the encrypted challenge key E(KPd3, Kc2) and the certificate C[KPd2] of the storage device 200 output from the certificate output unit 222, thereby creating the first challenge information E(KPd3, Kc2)//C[KPd2]. The first challenge information E(KPd3, Kc2)//C[KPd2] thus created is output to the license using device 300.

The fifth decryption unit 232 decrypts the data using the challenge key Kc2 generated by the random number generating unit 221. Specifically, the fifth decryption unit 232 decrypts the second challenge information E(Kc2, E(KPd2, KPp3)) received from the license using device 300, using the challenge key Kc2 generated by the random number generating unit 221. The encrypted unique public key E(KPd2, KPp3) thus acquired is transmitted to the sixth decryption unit 233.

The sixth decryption unit 233 decrypts the data which has been encrypted using the public key KPp2 of the storage device 200. Specifically, the sixth decryption unit 233 decrypts the encrypted unique public key E(KPd2, KPp3) transmitted from the fifth decryption unit 232, using the private key Kd2 of the storage device 200, thereby acquiring the public key KPp3 of the license using device 300. The public key KPp3 thus acquired is transmitted to the fifth encryption unit 234 and the sixth encryption unit 236.

The fifth encryption unit 234 encrypts the data using the public key KPp3 of the license using device 300. Specifically, the fifth encryption unit 234 links the bus key Kb2 generated by the random number generating unit 221 and the identification information DID with regard to the storage device 200. Then, the fifth encryption unit 234 encrypts the linked data, thereby creating the connection information E(KPp3, Kb2//DID).

The seventh decryption unit 235 decrypts the data which has been encrypted using the bus key Kb2. Specifically, the seventh decryption unit 235 decrypts the session information E(Kb2, Ks3) provided from the license using device 300, thereby acquiring the session key Ks3 issued by the license using device 300. The session key Ks3 thus acquired is transmitted to the seventh encryption unit 237.

The sixth encryption unit 236 encrypts the data using the public key KPp3 of the license using device 300. Specifically, in a case of providing the license data to the license using device 300, the sixth encryption unit 236 encrypts the license data LIC using the public key KPp3 received from the license using device 300. The license data LIC is read out from the tamper-resistant storage unit 204, and is transmitted to the sixth encryption unit 236 through the data bus 210, the control unit 220, and the local bus 240, according to instructions from the controller 201. The encrypted license data E(KPp3, LIC) is transmitted to the seventh encryption unit 237.

The seventh encryption unit 237 encrypts the data using the session key Ks3 issued by the license using device 300. Specifically, the seventh encryption unit 237 further encrypts the encrypted license data E(KPp3, LIC), which has been encrypted by the sixth encryption unit 236, using the session key Ks3, thereby creating encrypted license data E(Ks3, E(KPp3, LIC)).

The signature computation unit 238 links: the bus key Kb1 issued by the license providing device 100 or the bus key Kb2 generated by the random number generating unit 221; and the data. Furthermore, the signature computation unit 238 performs hash-function computation for the linked data. Thus, the signature computation unit 238 creates digital signature data in a keyed-hash format using the bus key Kb1 or Kb2. The digital signature data is used for detection whether or not the data has been forged, for exchange of the data with a device with which the bus key has been shared.

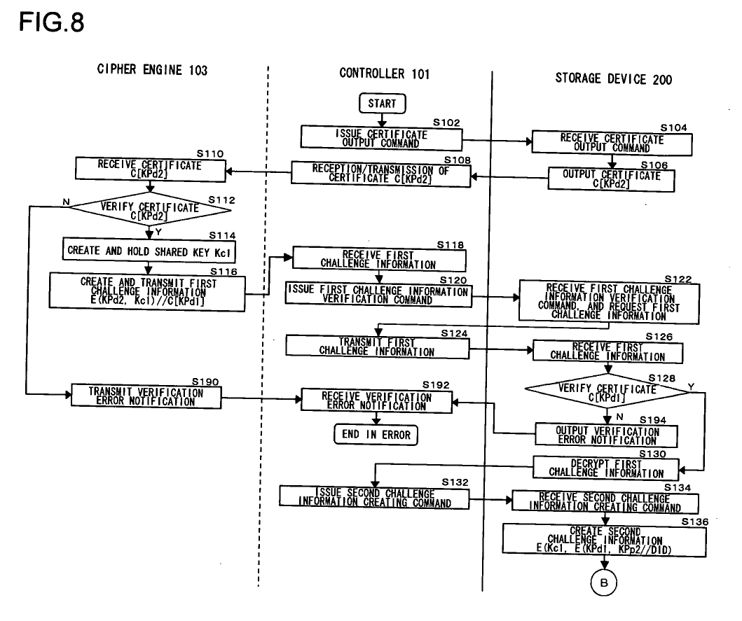

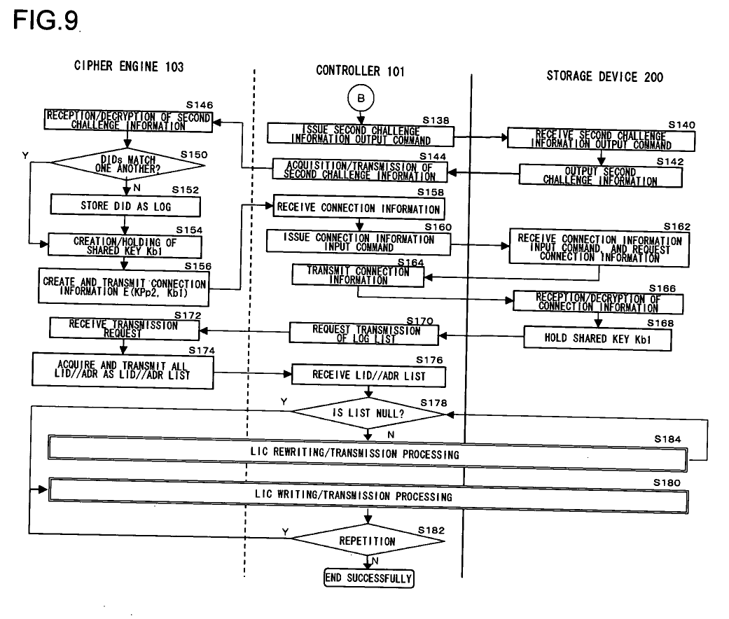

FIGS. 8 and 9 show a procedure up to the step where the license providing device 100 stores the license data LIC in the storage device 200. In the storage processing, an encrypted communication path is established between the cipher engine 103 of the license providing device 100 and the cipher engine 203 of the storage device 200. The license data LIC is transmitted from the license providing device 100 to the storage device 200 through the encrypted communication path. In the drawings, the processing is classified into three processing groups of: the processing group performed by the cipher engine 103 of the license providing device 100; the processing group performed by the controller 101 of the license providing device 100; and the processing group performed by the cipher engine 203 of the storage device 200.

First, the controller 101 of the license providing device 100 issues a certificate output command to the storage device 200 (S102). Upon successful reception of the certificate output command (S104), the controller 201 instructs the cipher engine 203 to output the certificate. Then, the controller 201 reads out the certificate C[KPd2] from the cipher engine 203, and outputs the certificate C[KPd2] to the controller 101 (S106). Upon acquisition of the certificate C[KPd2] from the storage device 200, the controller 101 transmits the certificate C[KPd2] to the cipher engine 103 (S108).

Upon reception of the certificate C[KPd2] issued by the storage device 200 (S110), the control unit 130 of the cipher engine 103 transmits the certificate C[KPd2] to the cipher engine 103. Then, the certificate verification unit 120 verifies the certificate using the verification key KPa (S112).

In a case that the certificate has not been authenticated (in a case of “NO” in S112), the certificate verification unit 120 transmits an error notification to the control unit 130. Upon reception of the error notification, the control unit 130 transmits a verification-error notification to the controller 101 (S190). In a case that the controller 101 has received the verification-error notification (S192), the processing ends in error.

In a case that the certificate has been authenticated (in a case of “YES” in S112), the control unit 130 generates the challenge key Kc1 at the random number generating unit 121. The challenge key Kc1 thus generated is transmitted to the first encryption unit 122 and the first decryption unit 123. The first decryption unit 123 holds the challenge key Kc1 therein (S114). On the other hand, the first encryption unit 122 encrypts the challenge key Kc1 using the public key KPd2 of the storage device 200 acquired from the certificate C[KPd2], thereby creating an encrypted challenge key E(KPd2, Kc1). Then, the control unit 130 links the encrypted challenge key E(KPd2, Kc1) and the certificate C[KPd1] of the license providing device 100 output from the certificate output unit 129, thereby creating first challenge information E(KPd2, Kc1)//C[KPd1], and transmits the first challenge information thus created, to the controller 101 (S116).

Upon reception of the first challenge information E(KPd2, Kc1)//C[KPd1] from the cipher engine 103 (S118), the controller 101 issues a first challenge information verification command to the storage device 200 (S120). Upon the controller 201 of the storage device 200 receiving the first challenge information verification command, the storage device 200 requests the controller 101 to output the first challenge information E(KPd2, Kc1)//C[KPd1] (S122). In response to the request, the controller 101 outputs the first challenge information E(KPd2, Kc1)//C[KPd1] to the storage device 200 (S124).

Upon the storage device 200 receiving the first challenge information E(KPd2, Kc1)//C[KPd1] (S126), the control unit 220 of the cipher engine 203 acquires the certificate C[KPd1] from the first challenge information E(KPd2, Kc1)//C[KPd1], and transmits the certificate C[KPd1] to the certificate verification unit 223. The certificate verification unit 223 verifies the received certificate C[KPd1] using the verification key KPa, and transmits the verification results to the control unit 220 (S128).

In a case that the certificate has not been authenticated (in a case of “NO” in S128), the certificate verification unit 223 transmits a verification-error notification to the control unit 220. Then, the control unit 220 notifies the controller 201 of the verification-error notification. Subsequently, the controller 201 transmits the verification-error notification thus received, to the controller 101 through the storage interface 202 (S194). In a case that the controller 101 has received the verification-error notification (S192), the processing ends in error.

In a case that the certificate has been authenticated (in a case of “YES” in S128), the control unit 220 acquires the public key KPd1 and the encrypted challenge key E(KPd2, Kc1) from the first challenge information E(KPd2, Kc1)//C[KPd1]. The public key KPd1 and the encrypted challenge key E(KPd2, Kc1) are transmitted to the first encryption unit 225 and the first decryption unit 224, respectively. The first encryption unit 225 holds the public key KPd1 thus received. On the other hand, the first decryption unit 224 decrypts the encrypted challenge key E(KPd2, Kc1) thus received, using the private key Kd2 of the storage device 200, thereby acquiring the challenge key Kc1 (S130). Then, the challenge key Kc1 thus acquired is transmitted to the second encryption unit 226.

On the other hand, upon completion of the processing in the storage device 200 according to the first challenge information verification command, the controller 101 issues a second challenge information creating command to the storage device 200 (S132). Upon the controller 201 of the storage device 200 receiving the second challenge information creating command (S134), in the cipher engine 203, the first encryption unit 225 encrypts the linked data, in which the public key KPp2 and the identification information DID that allows identification thereof have been linked, using the public key KPd1, thereby creating the encrypted unique information E(KPd1, KPp2//DID). Here, the public key KPp2 forms a pair with the private key Kp2 held by the storage device 200 with high security. The encrypted unique information E(KPd1, KPp2//DID) is transmitted to the second encryption unit 226. The second encryption unit 226 encrypts the encrypted unique information E(KPd1, KPp2//DID) using the challenge key Kc1 held in S130, thereby creating the second challenge information E(Kc1, E(KPd1, KPp2//DID)) (S136).

Upon completion of the processing in the storage device 200 according to the second challenge information creating command, the controller 101 issues a second challenge information output command (S138). Upon the storage device 200 receiving the second challenge information output command (S140), the controller 201 reads out the second challenge information E(Kc1, E(KPd1, KPp2//DID)) from the cipher engine 203, and outputs the second challenge information to the controller 101 (S142). Upon the controller 101 receiving the second challenge information E(Kc1, E(KPd1, KPp2//DID)) from the storage device 200, the controller 101 transmits the second challenge information to the cipher engine 103 (S144).

Upon receiving the second challenge information E(Kc1, E(KPd1, KPp2//DID)), the control unit 130 of the cipher engine 103 transmits the second challenge information to the first decryption unit 123. The first decryption unit 123 decrypts the second challenge information E(Kc1, E(KPd1, KPp2//DID)) thus received, using the challenge key Kc1 held therein, thereby acquiring the encrypted unique information E(KPd1, KPp2//DID). The encrypted unique information thus acquired is transmitted to the second decryption unit 124. The second decryption unit 124 decrypts the encrypted unique information using the private key Kd1 thereof, thereby acquiring the public key KPp2 of the storage device and the identification information DID. The public key KPp2 is transmitted to the second encryption unit 125 and the third encryption unit 127. On the other hand, the identification information DID is transmitted to the control unit 130 (S146).

Upon receiving the identification information DID, the control unit 130 compares the identification information DID thus received with the identification information DID stored in the log storage unit 131 (S150). At that time, the log storage unit 131 stores the identification information DID with regard to the storage device immediately prior to this connection. In a case that these DIDs match one another (in a case of “YES” in S150), determination is made that the same storage device has been used as with the previous connection, and the flow proceeds to S154 without change of the data stored in the log storage unit 131. On the other hand, in a case that these DIDs do not match one another (in a case of “NO” in S150), determination is made that the storage device has been replaced with another. In this case, the data stored in the log storage unit 131 is meaningless. In this case, the control unit 130 deletes the data stored in the log storage unit 131, and stores the identification information DID acquired in S146 in this connection (S152). Thus, the information necessary for recovery processing, which might be performed in transmission of the license data LIC to the storage device 200, has been completed. Then, the flow proceeds to S154.

The control unit 130 creates the bus key Kb1 at the random number generating unit 121, and holds the bus key Kb1 (S154). Then, the control unit 130 transmits the bus key Kb1 held therein, to the second encryption unit 125, the third decryption unit 126, and the signature computation unit 132. The second encryption unit 125 encrypts the bus key Kb1 using the public key KPp2 of the storage device acquired in S146, thereby creating the connection information E(KPp2, Kb1). The connection information E(KPp2, Kb1) thus created is transmitted to the controller 101 (S156).

Upon receiving the connection information E(KPp2, Kb1) from the cipher engine 103 (S158), the controller 101 issues a connection information input command to the storage device 200 (S160). Upon receiving the connection information input command, the controller 201 of the storage device 200 requests the controller 101 to output the connection information E(KPp2, Kb1) (S162). The controller 101 outputs the connection information E(KPp2, Kb1) to the storage device 200 in response to the request (S164).

Upon the-storage device 200 receiving the connection information E(KPp2, Kb1), the cipher engine 203 decrypts the connection information E(KPp2, Kb1) using the private key Kp2 thereof held therein, thereby acquiring the bus key Kb1 (S166). The storage device 200 holds the bus key Kb1 therein (S168). The bus key Kb1 thus held is transmitted to the third encryption unit 228 and the signature computation unit 238. With the procedure described above, the bus key Kb1 is shared between the cipher engines 103 and 203.

On the other hand, upon completion of the processing in the storage device 200 according to the connection information input command, the controller 101 requests the cipher engine 103 to transmit a public log information list stored in the log storage unit 131 (S170). With the present embodiment, an LID//ADR list is used as the public log information list. The LID//ADR list lists: the identification information LID with regard to the license data, in which transmission processing to the storage device 200 has not been completed; and the address information ADR with regard to the storage device in which the license data is to be stored. In a case that the storage device mounted in the previous connection does not match the storage device 200 in the current connection, the information stored in the log storage device 131 is cleared in S152. In this case, the log storage unit 131 outputs a null list.

Upon receiving the transmission request for the LID//ADR list (S172), the control unit 130 of the cipher engine 103 creates the LID//ADR list with reference to the information stored in the log storage unit 131. The cipher engine 103 transmits the LID//ADR list to the controller 101 (S174).

Upon receiving the LID//ADR list (S176), the controller 101 checks whether or not the LID//ADR list is null (S178). In a case that the LID//ADR list is null (in a case of “YES” in S178), i.e., in a case that writing of the license data to the storage device 200 has been already completed, or writing of the license data has not been completed at all, the flow proceeds to S180 for normal writing/transmission processing for the license data (LIC writing/transmission processing). Detailed description will be made later regarding the license-data writing/transmission processing (LIC writing/transmission processing).

On the other hand, in a case that the LID//ADR list has any data (in a case of “NO” in S178), the flow proceeds to S184 for performing license-data rewriting/transmission processing (LIC rewriting/transmission processing) for the first data listed on the LID//ADR list. Only in a case that determination has been made that the license data needs to be rewritten, the license data is rewritten (S184). Detailed description will be made later regarding the license-data rewriting/transmission processing (LIC rewriting/transmission processing). Note that the first data listed on the LID//ADR list is deleted therefrom immediately prior to or after S184, which is omitted in the drawings.

Upon completion of a set of the rewriting/transmission processing, the flow returns to S178, and the processing described above is repeated until the LID//ADR list is nullified. Upon the LID//ADR list being nullified (in a case of “YES” in S178), i.e., in a case that there is no need to perform the rewriting/transmission processing, the flow proceeds to S180 for performing the writing/transmission processing for new license data LIC.

Upon completion of the processing in S180, the controller 101 determines whether or not the new license data should be written (S182). In a case that the new license data should be written to the storage device 200 (in a case of “YES” in S182), the flow returns to S180 for writing the license data. In a case that the new license data should not be written to the storage device 200 (in a case of “NO” in S182), the processing ends.

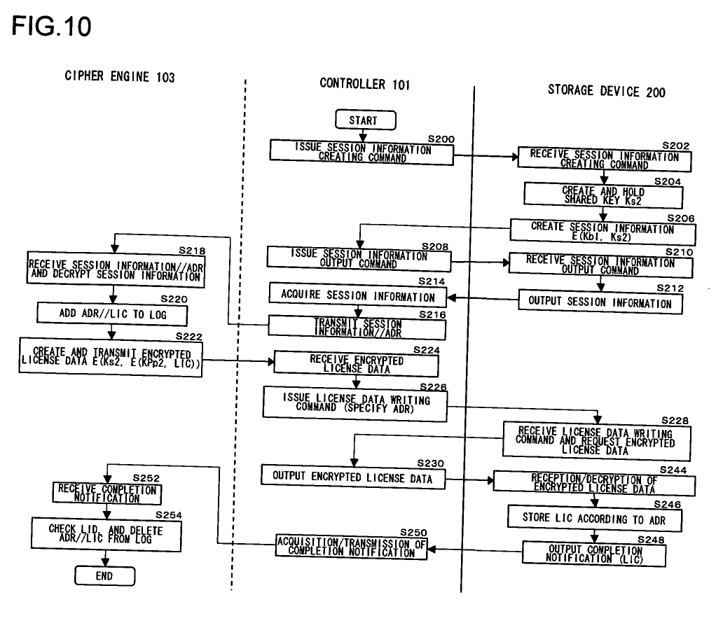

FIG. 10 is a flowchart which shows the license-data writing/transmission processing (LIC writing/transmission processing) shown in FIG. 9. Prior to the processing shown in the flowchart, the bus key Kb1 is shared between the cipher engine 103 and the storage device 200 (cipher engine 203), the cipher engine 103 holds the public key KPp2 of the storage device 200, and the log storage unit 131 of the cipher engine 103 stores the identification information DID with regard to the storage device 200.

The controller 101 issues a session information creating command to the storage device 200 (S200). In the storage device 200, upon the controller 201 receiving the session information creating command (S202), the cipher engine 203 creates the session key Ks2 at the random number generating unit 221 according to instructions from the control unit 220, and transmits the session key Ks2 thus created, to the third encryption unit 228 and the third decryption unit 229 (S204). Subsequently, the third encryption unit 228 encrypts the session key Ks2 thus received, using the bus key Kb1, thereby creating the session information E(Kb1, Ks2) (S206). Upon completion of the processing in the storage device 200 according to the session information creating command, the controller 101 issues a session information output command (S208). Upon the storage device 200 receiving the session information output command (S210), the controller 201 reads out the session information E(Kb1, Ks2) from the cipher engine 203, and outputs the session information E(Kb1, Ks2) to the controller 101 (S212).

Upon receiving the session information E(Kb1, Ks2) from the storage device 200 (S214), the controller 101 links the session information and the address data ADR data for the storage device 200, and transmits the linked data to the cipher engine 103 (S216). The address data ADR is used for specifying the address for storing the license data LIC in the following step.

Upon receiving the session information E(Kb1, Ks2)//ADR, to which the address data has been linked, the controller 130 of the cipher engine 103 separates the linked session information into the session information E(Kb1, Ks2) and the address data ADR. The session information E(Kb1, Ks2) is transmitted to the third decryption unit 126. The third decryption unit 126 decrypts the session information E(Kb1, Ks2) using the bus key Kb1 received from the random number generating unit 121, thereby acquiring the session key Ks2 (S218).

The control unit 130 stores the license data LIC and the address data ADR thus separated, in the log storage unit 131 in the form of additional information correlated with the information (identification information DID) for identifying the storage device 200 serving as a license receiver (S220). The log storage unit 131 statically stores the information to be used for the license-data rewriting processing in a case of interruption of the license-data writing processing, including a desirable case such as failure of the power supply.

Subsequently, the third encryption unit 127 of the cipher engine 103 encrypts the license data LIC using the public key KPp2 of the storage device 200, thereby creating encrypted license data E(KPp2, LIC). The encrypted license data E(KPp2, LIC) is transmitted to the fourth encryption unit 128. Then, the fourth encryption unit 128 further encrypts the encrypted license data E(KPp2, LIC) thus received, using the session key Ks2 issued by the storage device 200, thereby creating the encrypted license data E(Ks2, E(KPp2, LIC)). The encrypted license data E(Ks2, E(KPp2, LIC)) is transmitted to the controller 101 (S222).

Upon receiving the encrypted license data E(Ks2, E(KPp2, LIC)) from the cipher engine 103 (S224), the controller 101 issues a license data writing command to the storage device 200 (S226). The license writing command includes the address data ADR for specifying the recording location in the tamper-resistant storage unit 204. The address data ADR used here is the same as that transmitted to the cipher engine in S216. Note that the address as used here means “logical address”. While the logical address does not directly specify the recording location in the tamper-resistant storage unit 204, the controller 201 manages storage of data so as to allow readout of the data using the same logical address as in the writing processing. Also, the storage device 200 may employ the physical address for directly specifying the recording location in the tamper-resistant storage unit 204.

Upon receiving the license writing command issued by the controller 101, the storage device 200 requests the controller 101 to output the encrypted license data (S228). In response to the request, the controller 101 outputs the encrypted license data E(Ks2, E(KPp2, LIC)) to the storage device 200 (S230).

Upon receiving the encrypted license data E(Ks2, E(KPp2, LIC)), the storage device 200 transmits the encrypted license data to the third decryption unit 229 within the cipher engine 203. The third decryption unit 229 decrypts the encrypted license data E(Ks2, E(KPp2, LIC)) using the session key Ks2 held therein, thereby acquiring the encrypted license data E(KPp2, LIC), which has been encrypted using the public key KPp2 of the storage device 200. Then, the encrypted license data E(KPp2, LIC) thus acquired is transmitted to the fourth decryption unit 230.

The fourth decryption unit 230 decrypts the encrypted license data E(KPp2, LIC) thus received, using the private key Kp2 forming a pair along with the public key KPp2, thereby acquiring the license data LIC (S244). The license data LIC is output to the control unit 220 through the local bus 240.

The control unit 220 acquires the identification information LID from the license data LIC, and transmits the identification information LID to the log storage unit 131. Furthermore, the license data LIC is output to the data bus 210. The controller 201 stores the license data LIC, output to the data bus 210, in the tamper-resistant storage unit 204 according to the specified address ADR (S246). Subsequently, the storage device 200 outputs a completion notification to the controller 101 (S248).

Upon receiving the completion notification output from the storage device 200, the controller 101 outputs the completion notification to the cipher engine 103 (S250). Upon receiving the completion notification (S252), the cipher engine 103 checks the LID, and deletes the corresponding ADR//LID from the log storage unit 131 (S254), whereby the processing ends.

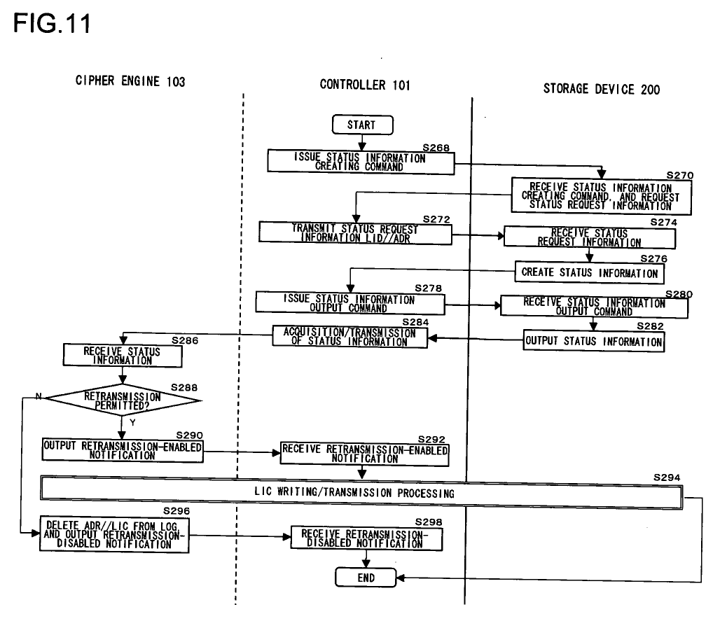

FIG. 11 is a flowchart which shows the license-data rewriting/transmission processing (LIC rewriting/transmission processing) shown in FIG. 9. The controller 101 issues a status information creating command to the storage device 200 (S268). Upon the controller 201 of the storage device 200 receiving the status information creating command, the storage device 200 requests the controller 101 to output status request information (S270). In response to the request, the controller 101 outputs the status request information LID//ADR to the storage device 200 (S272).

Upon receiving the status request information LID//ADR (S274), the storage device 200 requests the controller 201 to receive the license data LIC stored in the tamper-resistant storage unit 204 according to the address data ADR thus received. Then, the controller 201 determines whether or not the license data including the received identification information LID is stored in the storage device 200, or whether or not the license data has been moved after storage, and creates the determination results in the form of the status information ST2. Then, the controller 201 links the status information ST2 and the LID//ADR thus received, thereby creating the data sequence LID//ADR//ST2. Subsequently, the data sequence LID//ADR//ST2 is transmitted to the signature computation unit 238. The signature computation unit 238 performs hash-function computation for the data sequence in which the bus key Kb1 stored in the cipher engine 203 and the data sequence LID//ADR//ST2 have been linked, thereby computing signature data H(Kb1//LID//ADR//ST2). The control unit 220 receives the computation results, and links the computation results and the data sequence, thereby creating transaction status information LID//ADR//ST2//H(Kb1//LID//ADR//ST2) (S276).

Upon completion of the processing in the storage device 200 according to the status information creating command, the controller 101 issues a status information output command (S278). Upon the storage device 200 receiving the status information output command (S280), the controller 201 reads out the transaction status information from the cipher engine 203, and outputs the transaction status information to the controller 101 (S282). Upon receiving the transaction status information from the storage device 200, the controller 101 outputs the transaction status information to the cipher engine 103 (S284).

Upon receiving the transaction status information (S286), the cipher engine 103 verifies the transaction status information according to instructions from the control unit 130. The cipher engine 103 determines whether or not the license data can be retransmitted based upon the determination result whether or not the transaction status information is valid (S288).

The verification is performed with respect to the following conditions. The conditions include: Condition 1) the transaction status information is valid; Condition 2) the storage has not been completed in the storage device 200; and Condition 3) the log storage unit 131 stores the data of the corresponding license data. In a case that all the these three conditions are satisfied, the cipher engine 103 determines that retransmission can be performed. On the other hand, in a case that any one of these three conditions is not satisfied, the cipher engine 103 determines that retransmission cannot be performed. Detailed description will be made below regarding each step of the determination processing.

Verification of the validity of the transaction status information is performed as follows. The control unit 130 of the cipher engine 103 separates the transaction status information LID//ADR//ST2//H(Kb1//LID//ADR//ST2) into the data sequences LID//ADR//ST2 and the signature data H(Kb1//LID//ADR//ST2), and transmits the data sequence LID//ADR//ST2 to the signature computation unit 132. The signature computation unit 132 links the bus key Kb1 held in the cipher engine 103 and the data sequence LID//ADR//ST2, thereby creating the data sequence Kb1//LID//ADR//ST2. Furthermore, the signature computation unit 132 performs the hash-function computation for the data sequence thus created. The control unit 130 receives the computation result, and compares the computation result with the signature data H(Kb1//LID//ADR//ST2) separated in the previous step. In a case that the computation result matches the signature data, determination is made that the transaction status information is valid, i.e., the validity of the transaction status information has been verified. On the other hand, in a case that the computation result does not match the signature data, determination is made that the transaction status information is not valid, i.e., the validity of the transaction status information has not been verified.

Furthermore, the control unit 130 checks the status information ST2 in the transaction status information so as to confirm whether or not storage of the license data LIC including the corresponding LID has been completed. In a case that the status information ST2 indicates that the license data LIC is stored in the storage device 200, or indicates that the license data LIC has been moved after storage, determination is made that storage of the license data LIC has been completed. Otherwise, determination is made that the storage has not been completed.

Subsequently, the control unit 130 refers to the log storage unit 131. In a case that the license data LIC including the identification information LID acquired from the transaction status information is stored in the log storage unit 131, and the address data ADR stored in the log storage unit 131 in a form correlated with the license data LIC matches the address data ADR acquired from the transaction status information, determination is made that the license data LIC is stored in the log storage unit 131. Otherwise, determination is made that the license data is not stored in the log storage unit 131.

In a case that the control unit 130 has determined that the license data can be retransmitted in S288 (in a case of “YES” in S288), the control unit 130 transmits a retransmission-enabled notification to the controller 101 (S290). Upon the controller 101 receiving the retransmission-enabled notification (S292), the flow proceeds to Step S294 where the control unit 101 performs license-data writing/transmission processing (LIC writing/transmission processing), following which the processing ends. In this case, an arrangement may be made in which the license data LIC stored in the log storage unit 131 is read out, and the encrypted license data is created in S222.

In a case that determination has been made that the license data cannot be retransmitted in S288 (in a case of “NO” in S288), the flow proceeds to S296. In a case that determination has been made that the license data cannot be retransmitted since the conditions 1) and 3) are satisfied, but the condition 2) is not satisfied, the information regarding the license data is deleted from the log storage unit 131. Also, an arrangement may be made in which the license data is not deleted in such a case, which leaves no problem. Then, the control unit 130 transmits a retransmission-disabled notification to the controller 101 (S296). Upon the controller 101 receiving the retransmission-disabled notification (S298), the processing ends.

With the procedure described above, the license data, which is necessary for decrypting and reproducing the encrypted contents, is stored in the storage device 200. On the other hand, the encrypted contents data is ordinary data. With the present embodiment, the encrypted contents data is stored according to ordinary commands, and accordingly, description thereof will be omitted.

Note that the recording order of the license data and the encrypted contents data is not restricted. Furthermore, an arrangement may be made in which the secure command is issued in a divided form using free time in which the storage device 200 is not storing the encrypted contents data, thereby recording the license data.

Note that FIGS. 8 and 11 show an example of the procedure in which the license data LIC transmitted from the license providing device 100 is stored in the storage device 200, and the processing ends successfully. In a case of interruption of the processing due to one cause or another, the processing is executed based upon the data stored in the log storage unit 131 of the cipher engine 103, i.e., the license rewriting/transmission processing is executed as necessary.

With the present embodiment, the log storage unit 131 stores information regarding only the storage device immediately prior to the current connection. That is to say, description has been made regarding an arrangement in which in the event that the identification information DID acquired from the storage device 200 is different from the identification information DID stored in the log storage unit 131, the log storage unit 131 is cleared, and stores the identification information DID newly received. Also, an arrangement may made in which the log storage unit 131 has a space for storing information regarding multiple storage devices, and stores information regarding multiple storage devices which have been connected previously.

Description has been made in the present embodiment regarding an arrangement in which the identification information DID, which is provided from the storage device 200 to the cipher engine 103 through the encrypted communication path connected therebetween, is stored in the log storage unit 131 for identifying the storage device 200 serving as a receiver in the license rewriting/transmission processing. However, the present invention is not restricted to such an arrangement. Rather, any information may be employed for identifying the storage device 200, so long as the information allows determination whether or not the storage device 200 has replaced with another, i.e., whether or not the same storage device 200 is connected as with the previous communication. Examples of such information according to the present invention include the public keys KPd2 and KPp2 of the storage device. Also, an arrangement may be made in which the storage device 200 has a space which allows static and high-security storage of the information shared through an encrypted communication, and this information is employed for identifying the storage device 200. Examples of such information according to the present embodiment include the challenge key Kc1 and the bus key Kb1. Also, an arrangement may be made by making a combination of the aforementioned arrangements; in which multiple information sets are employed for identifying the license receiver.

While description has been made regarding an arrangement having a function for deleting the data stored in the log storage unit 131, the present invention is not restricted to such an arrangement in which the data is physically deleted. An arrangement may be made having a function of enabling/disabling the data for each log data using an enable/disable flag, instead of a function for physically deleting the data. Also, an arrangement may be made having a function of enabling/disabling the data as follows. The log storage unit 131 has a storage area having a ring structure, and a pointer indicating the storage area is incremented as necessary. That is to say, any arrangement may be made, so long as the data, which has been used, cannot be used again.

The log storage unit 131 may store session status information which indicates the license-data transmission status. For example, upon receiving the session key from the storage device 200, the log storage unit 131 may store session status information SP (Send Prepared) which indicates that preparation of transmission has been completed. Also, upon transmission of the license data to the storage device 200, the log storage unit 131 may store session status information SC (Send Completed) which indicates that transmission has been completed. In this case, an arrangement may be made in which in the event that the session status information stored in the log storage unit 131 is set to SC, retransmission is permitted, otherwise, retransmission is forbidden.

Also, the storage device 200 may store session status information. For example, upon transmission of the session key from the storage device 200 to the license providing device 100, an unshown log storage unit of the storage device 200 may store session status information RP (Receive Prepared) which indicates that preparation of reception has been completed. Also, upon receiving the license data from the license providing device 100, the log storage unit of the storage device 200 may store session status information RC (Receive Completed) which indicates that reception has been completed. Also, the transaction status information including the session status information may be transmitted to the license providing device 100. In such an arrangement, determination may be made whether or not retransmission is permitted as follows. That is to say, in a case that the session status information regarding the storage device 200 is set to RP or RC, and the status information ST indicates that the storage device 200 does not store the license data LIC, retransmission is permitted. Otherwise, retransmission is forbidden.

While description has been made regarding an arrangement in which the encrypted license data is employed in the form of E(Ks2, E(KPp2, LIC)), the present invention is not restricted to the order in which the license data is encrypted twofold. Also, the present invention is not restricted to an arrangement employing the license data encrypted twofold. Rather, the encrypted license data may be employed in any form, so long as key sharing is performed between the license transmitter (in this case, the cipher engine 103) and the license receiver (in this case, storage device 200), and the license data encrypted using a key shared therebetween is transmitted.

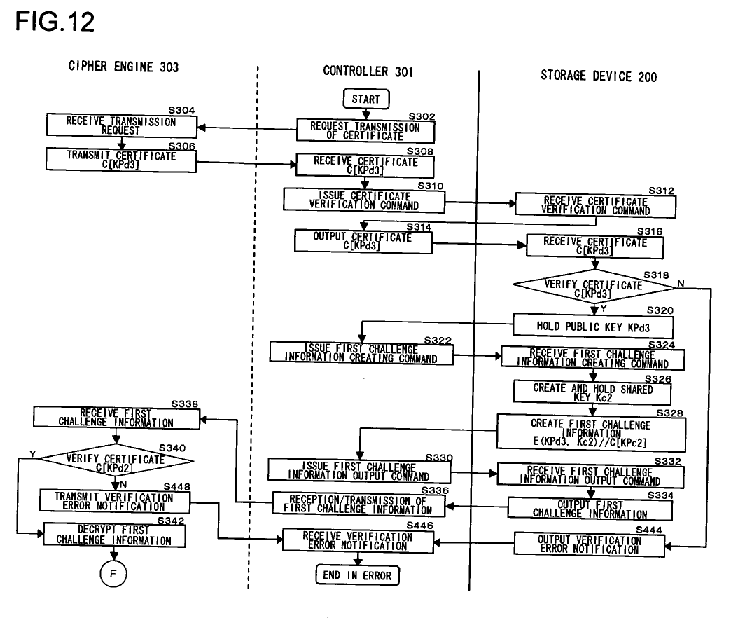

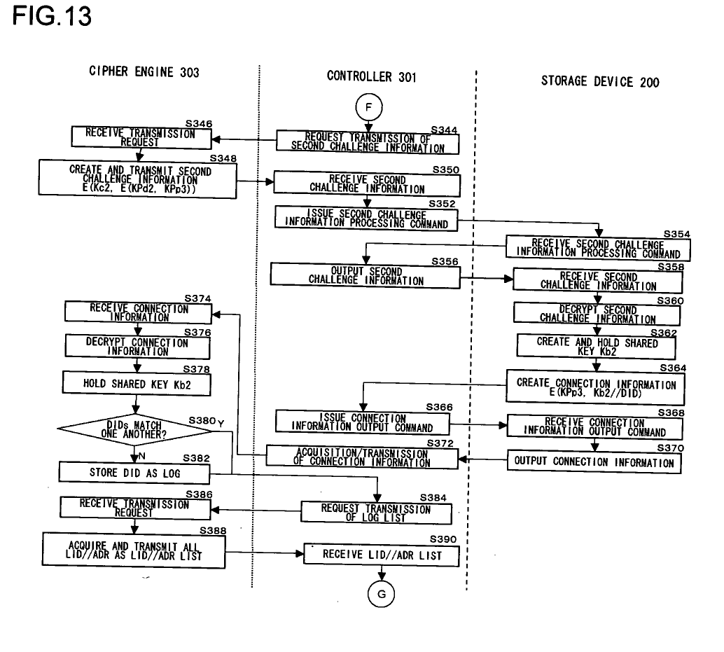

FIGS. 12 through 14 show a procedure for reproduction processing up to the step in which the license using device 300 reads out the license data LIC from the storage device 200, and discards the contents key thus read out. With the reproduction processing, an encrypted communication path is established between the cipher engine 203 of the storage device 200 and the cipher engine 303 of the license using device 300. The license data LIC is transmitted from the storage device 200 to the license using device 300 through the encrypted communication path thus established. In the drawings, the processing is classified into three processing groups of: the processing group performed by the cipher engine 203 of the storage device 200; the processing group performed by the cipher engine 303 of the license using device 300; and the processing group performed by the controller 301 of the license using device 300 for controlling exchange of data between the storage device 200 and the cipher engine 303.

The license data is used according to the procedure shown in the flowchart.

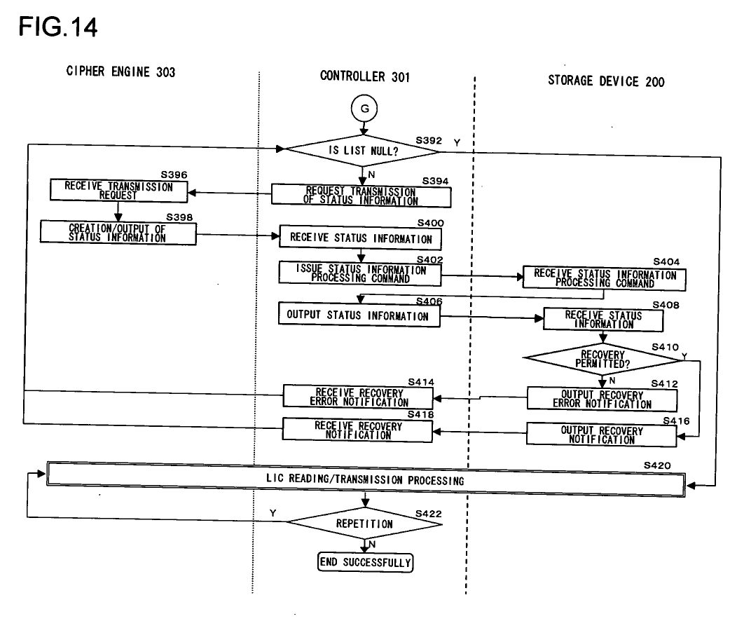

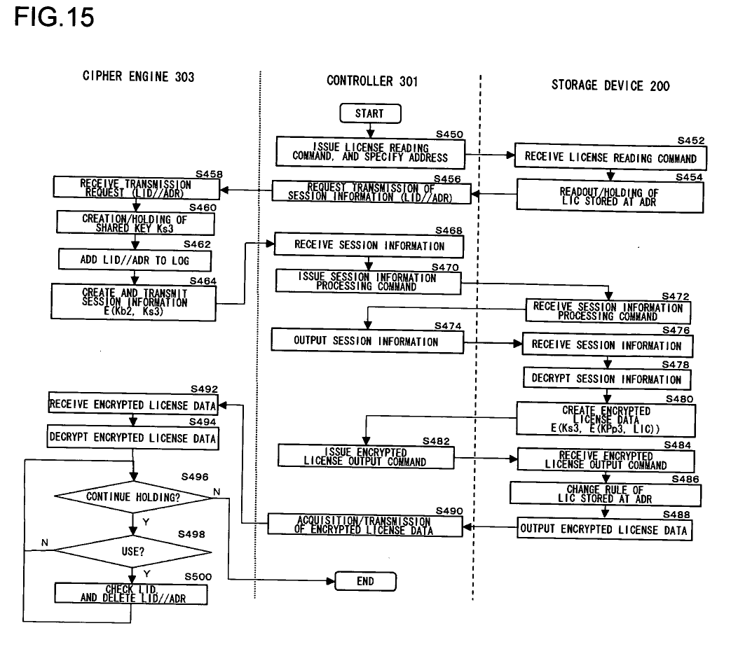

FIG. 15 is a flowchart which shows readout/transmission processing for the license data (LIC readout/transmission processing) shown in FIG. 14. The license-data readout/transmission processing (LIC readout/transmission processing) is performed according to the procedure shown in the flowchart.

As described above, description has been made regarding the embodiments according to the present invention. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

For example, while description has been made in the aforementioned embodiments regarding arrangements in which the cipher engine includes separate functional blocks for the encryption function and the decryption function, respectively. Also an arrangement may be made in which such functional blocks share the circuit on a component basis. This enables a reduced circuit scale, thereby reducing the size of the system and power consumption thereof.

With the present invention, various modifications may be made as appropriate within the scope of the technical idea of the present invention as laid forth in the appended claims.

What is claimed is:

1. A method for transmitting content usage right information including a content key for decrypting encrypted content data comprising:
sharing at least one encryption/decryption key between a transmitter and a receiver for transmission/reception of said content usage right information;
processing in which said transmitter transmits the encrypted content usage right information to said receiver in an encrypted form using said at least one encryption/decryption key shared;
processing in which said transmitter stores identification information regarding the content usage right information, which is transmitted to said receiver, in a log storage unit in a form correlated with identification information regarding said receiver;
notifying a retransmission receiver of identification information regarding the content usage right information, which is to be retransmitted, in a case that said content usage right information needs to be retransmitted;
processing in which said retransmission receiver confirms the status of the content usage right information, which is to be retransmitted, based upon the identification information regarding the content usage right information thus received, creates transaction status information including the identification information, which is to be retransmitted, and the status information regarding the content usage right information, and transmits said transaction status information to said transmitter;
processing in which said transmitter acquires said transaction status information, and determines whether or not transmission of the content usage right information, which is to be retransmitted to said retransmission receiver, is permitted, and
processing in which in the event that transmission has been permitted, said transmitter retransmits the content usage right information, which is to be retransmitted, to said retransmission receiver,
wherein in said determination, in the event that the identification information regarding the content usage right information included in said transaction status information is held in said log storage unit in a form correlated with the identification information regarding said retransmission receiver, and the status information regarding said content usage right information indicates that the content usage right information, which is to be retransmitted, is not stored in said retransmission receiver, transmission of the content usage right information, which is to be retransmitted to said retransmission receiver, is permitted.

2. A content usage right information transmission method according to claim 1, wherein in said determination, in the event that said status information regarding the content usage right information indicates that the content usage right information, which is to be retransmitted, is stored in said retransmission receiver, or indicates that the content usage right information has been moved after reception, transmission of the content usage right information, which is to be retransmitted to said retransmission receiver, is forbidden.

3. A content usage right information transmission method according to claim 1, wherein said retransmission receiver calculates a hash value of linked data in which said encryption key shared with said transmitter and said transaction status information have been linked, and transmits the hash value and said transaction status information to said transmitter,
and wherein in said determination, a hash value is calculated from linked data in which said transaction status information received from said retransmission receiver and said encryption key shared with said receiver have been linked, and validity of said transaction status information is verified by making a comparison between said hash value thus calculated and said hash value received from said retransmission receiver,
and wherein in the event that these hash values do not match one another, transmission of the content usage right information, which is to be retransmitted to said retransmission receiver, is forbidden.

4. A content usage right information transmission method according to claim 1, further including a processing in which upon receiving a notification that said receiver has received the content usage right information successfully after transmission of said content usage right information to said receiver, the identification information regarding said content usage right information is deleted from said log storage unit,
wherein upon connection of said transmitter to said retransmission receiver, identification information regarding said retransmission receiver is acquired,
and wherein in the event that said log storage unit stores the identification information regarding the content usage right information in a form correlated with the identification information regarding said retransmission receiver, determination is made that said content usage right information needs to be retransmitted.

5. A content usage right information transmission method according to claim 1, further including a processing in which upon connection of said transmitter to said retransmission receiver, said transmitter acquires the identification information regarding said retransmission receiver, and the identification information regarding the content usage right information, which is stored in said log storage unit in a form correlated with the identification information different from the identification information regarding said retransmission receiver, is deleted from said log storage unit.

6. A content usage right information transmission method according to claim 1, wherein said log storage unit further holds an address at which said content usage right information is stored in said receiver,
and wherein said transaction status information further includes an address at which said content usage right information has been stored or is to be stored in said retransmission receiver,
and wherein in said determination, comparison is made between the address held in said log storage unit and the address included in said transaction status information,
and wherein in the event that these addresses do not match one another, transmission of the content usage right information, which is to be retransmitted to said retransmission receiver, is forbidden.

7. A content usage right information transmission method according to claim 1, wherein said log storage unit further holds the content usage right information transmitted to said receiver,
and wherein in said retransmission, said content usage right information read out from said log storage unit is transmitted.

8. A content usage right information transmission method according to claim 1, wherein said log storage unit further holds transmitter session information which indicates a status of transmission of the content usage right information to said receiver,
and wherein in said determination, in the event that said transmitter session information held in said log storage unit for the content usage right information, which is to be retransmitted, indicates that the transmission of said content usage right information has been completed, transmission of said content usage right information, which is to be retransmitted to said retransmission receiver, is permitted.

9. A content usage right information transmission method according to claim 1, wherein said transaction status information further includes receiver session information which indicates a status of reception of the content usage right information,
and wherein in said determination, in the event that said receiver session information included in said transaction status information indicates that reception of the content usage right information, which is to be retransmitted, has not been completed, or in the event that said receiver session information included in said transaction status information indicates that reception of the content usage right information, which is to be retransmitted, has been completed, and the status information regarding the content usage right information included in said transaction status information indicates that the content usage right information, which is to be retransmitted, is not stored in said retransmission receiver, transmission of said content usage right information, which is to be retransmitted to said retransmission receiver, is permitted.

10. A content usage right information providing device which provides content usage right information containing a content key for decrypting encrypted content data to a content usage right information receiving device which uses the content usage right information, comprising:
encryption key sharing means for sharing at least one encryption key with said content usage right information receiving device, which is used for transmission of said content usage right information to said content usage right information receiving device;
content usage right information transmission means for transmitting said content usage right information to said content usage right information receiving device in a form encrypted with said at least one encryption key;
log storage means for storing identification information regarding said content usage right information, which is to be transmitted to said content usage right information receiving device, in a log storage unit in a form correlated with the identification information regarding said content usage right information receiving device;
status information acquisition means for acquiring identification information regarding the content usage right information, which is to be retransmitted, and transaction status information including status information regarding the content usage right information corresponding to the content usage right information receiving device, in the event that there is the need to retransmit said content usage right information; and
retransmission determination means wherein in the event that the identification information regarding the content usage right information included in the transaction status information acquired by said status information acquisition means is held in said log storage unit in a form correlated with the identification information regarding the content usage right information receiving device serving as a retransmission receiver, and the status information regarding said content usage right information indicates that the content usage right information, which is to be retransmitted, is not stored in said content usage right information receiving device serving as a retransmission receiver, retransmission of the content usage right information, which is to be retransmitted to said content usage right information receiving device serving as a retransmission receiver, is permitted.

11. A content usage right information providing device according to claim 10, wherein with said retransmission determination means, in the event that said status information regarding the content usage right information indicates that the content usage right information, which is to be retransmitted, is stored in said content usage right information receiving device serving as a retransmission receiver, or indicates that the content usage right information has been moved after reception, transmission of the content usage right information, which is to be retransmitted to said retransmission receiver, is forbidden.

12. A content usage right information providing device according to claim 10, wherein said status information acquisition means acquire said transaction status information and a hash value of linked data, in which said encryption key and said transaction status information have been linked, from said content usage right information receiving device serving as a retransmission receiver,
and wherein with said retransmission determination means, a hash value is calculated from linked data in which said transaction status information acquired by said status information acquisition means and said encryption key shared with said content usage right information receiving device have been linked, and validity of said transaction status information is verified by making a comparison between said hash value thus calculated and said hash value acquired by said status information acquisition means,
and wherein in the event that these hash values do not match one another, transmission of the content usage right information, which is to be retransmitted to said retransmission receiver, is forbidden.

13. A content usage right information providing device according to claim 10, wherein with said log storage means, upon receiving a notification from said content usage right information receiving device that said content usage right information receiving device has received the content usage right information successfully after transmission of said content usage right information to said content usage right information receiving device, the identification information regarding said content usage right information is deleted from said log storage unit,
and wherein with said status information acquisition means, upon connecting to said content usage right information receiving device serving as a retransmission receiver, identification information regarding said retransmission receiver is acquired,
and wherein in the event that said log storage unit stores the identification information regarding the content usage right information in a form correlated with the identification information regarding said content usage right information receiving device serving as a retransmission receiver, determination is made that said content usage right information needs to be retransmitted, and said status information acquisition means acquire said transaction status information.

14. A content usage right information providing device according to claim 10, wherein upon connection to said content usage right information receiving device serving as a retransmission receiver, said log storage means acquire the identification information regarding said retransmission receiver, and delete the identification information regarding the content usage right information, which is stored in a form correlated with the identification information different from the identification information regarding said content usage right information receiving device serving as a retransmission receiver.

15. A content usage right information providing device according to claim 10, wherein said log storage means further hold an address at which said content usage right information is stored in said content usage right information receiving device,
and wherein said transaction status information further includes an address at which said content usage right information has been stored or is to be stored in said content usage right information receiving device serving as a retransmission receiver,
and wherein said retransmission determination means make a comparison between the address held in said log storage unit and the address included in said transaction status information,
and wherein in the event that these addresses do not match one another, transmission of the content usage right information, which is to be retransmitted to said content usage right information receiving device serving as a retransmission receiver, is forbidden.

16. A content usage right information providing device according to claim 10, wherein with said log storage means, said log storage unit further stores the content usage right information transmitted to said content usage right information receiving device,
and wherein in a case of retransmission of the content usage right information, which is to be retransmitted, to said content usage right information receiving device serving as a retransmission receiver, said content usage right information transmission means transmit the content usage right information read out from said log storage unit.

17. A content usage right information providing device according to claim 10, wherein said log storage means further store transmitter session information which indicates a status of transmission of the content usage right information to said content usage right information receiving device,
and wherein with said retransmission determination means, in the event that said transmitter session information held in said log storage unit for the content usage right information, which is to be retransmitted, indicates that the transmission of said content usage right information has been completed, transmission of said content usage right information, which is to be retransmitted to said content usage right information receiving device serving as a retransmission receiver, is permitted.

18. A content usage right information providing device according to claim 10, wherein said transaction status information further includes receiver session information which indicates a status of reception of the content usage right information,
and wherein with said retransmission determination means, in the event that said receiver session information included in said transaction status information indicates that reception of the content usage right information, which is to be retransmitted, has not been completed, or in the event that said receiver session information included in said transaction status information indicates that reception of the content usage right information, which is to be retransmitted, has been completed, and the status information regarding the content usage right information included in
